(19) United States
(12) Patent Application Publication
(10) Pub. No.: US 2024/0286410 A1
(43) Pub. Date: Aug. 29, 2024

(54) IMAGE RECORDING APPARATUS

(71) Applicant: BROTHER KOGYO KABUSHIKI KAISHA, Nagoya (JP)

(72) Inventors: Misaki HARUHARA, Nagoya (JP); Nobumasa TANAKA, Nagoya (JP); Ryuji HORATA, Gamagori (JP); Takafumi NAKASE, Nagoya (JP); Isao KUBO, Tokoname (JP); Masahiro HAYASHI, Anjo (JP); Zenichiro SASAKI, Nagoya (JP)

(21) Appl. No.: 18/587,087

(22) Filed: Feb. 26, 2024

(30) Foreign Application Priority Data
Feb. 27, 2023 (JP) 2023-028480

(51) Int. Cl. B41J 2/165; B41J 2/045; B41J 2/17; B41J 2/175; B41J 11/00; B41J 29/13

(52) U.S. Cl. CPC B41J 2/16579; B41J 2/0451; B41J 2/04551; B41J 2/04586; B41J 2/16505; B41J 2/1721; B41J 2/17523; B41J 11/0095; B41J 29/13; B41J 2002/16594; B41J 2/1728; B41P 2235/27

(57) ABSTRACT

An image recording apparatus includes a head having nozzles, an expelling device, a discharge-testing device to output condition signals according to discharging conditions of the nozzles, a storage to store information concerning the condition signals, and a controller. In response to receipt of a record command, the controller controls the expelling device to expel a liquid from the nozzles based on the information concerning the condition signals stored in the storage, and thereafter, controls the head to discharge the liquid for recording an image on a recording medium. In response to receipt of a particular signal indicating a potential for receiving the record command, the controller executes a discharging-test process in which the controller controls the discharge-testing device to output the condition signals according to the discharging conditions of the nozzles and a storing process in which the information concerning the condition signals is stored in the storage.

### REFERENCE TO RELATED APPLICATIONS

This application claims priority from Japanese Patent Application No. 2023-028480, filed on Feb. 27, 2023. The entire content of the priority application is incorporated herein by reference.

### BACKGROUND ART

An image recording apparatus for recording an image by discharging liquid from nozzles is known. For example, a printer may discharge ink from nozzles to record an image on a recording sheet. The printer may drive an inkjet head for testing regularly at a predetermined time and collect information indicating whether each one of the nozzles is functioning correctly or malfunctioning. When the printer receives a record command that commands the printer to record an image, the printer may purge the ink from the nozzles based on the collected information, before recording an image on the recording sheet starts.

### SUMMARY

According to the known printer, after the inkjet head is driven for the test and the information indicating the conditions of the nozzles is collected, a long time may pass before the record command is received. In such a case, the condition of each nozzle, whether it is regularly functioning or malfunctioning, as indicated in the information collected earlier may differ largely from latest conditions of the nozzles at the time when the record command is received. Therefore, when the record command is received, the purging operation based on the collected information may not suit the conditions of the nozzles at the time of purging. Meanwhile, arrangement may be made such that, for example, the inkjet head may be driven for testing and the information indicating whether the nozzles are malfunctioning or not may be collected in response to receiving of the record command, and the printer may purge the ink from the nozzles based on the information collected recently. In such an arrangement, however, it may take longer time since the record command is received until recording of an image is started.

The present disclosure relates to an image recording apparatus, in which a time period from receipt of a record command to starting of image recording may be shortened or maintained to be as short as possible, and in which liquid may be expelled from nozzles more preferably based on recent conditions of the nozzles before an image is recorded on a recording medium.

According to an aspect of the present disclosure, an image recording apparatus includes a head, an expelling device, a discharge-testing device, a storage, and a controller. The head has nozzles and is configured to discharge liquid from the nozzles for recording an image on a recording medium. The expelling device is configured to expel the liquid from the nozzles. The discharge-testing device is configured to output condition signals according to discharging conditions of the nozzles. The storage is configured to store information concerning the condition signals. The controller is configured to, in response to receipt of a record command for recording the image, control the expelling device to expel the liquid from the nozzles based on the information concerning the condition signals stored in the storage, and thereafter, control the head to discharge the liquid for recording the image on the recording medium, and in response to receipt of a particular signal, which indicates a potential for receiving the record command, execute a discharging-test process in which the controller controls the discharge-testing device to output the condition signals according to the discharging conditions of the nozzles, and a storing process in which the information concerning the condition signals is stored in the storage.

According to another aspect of the present disclosure, an image recording apparatus includes a head, a receiver, a discharge-testing device, a storage, and a controller. The head has nozzles and is configured to discharge liquid from the nozzles for recording an image on a recording medium. The receiver is configured to receive the liquid discharged from the head. The discharge-testing device is configured to output condition signals according to discharging conditions of the nozzles. The storage is configured to store information concerning the condition signals. The controller is configured to, in response to receipt of a record command for recording the image, control the head to expel the liquid from the nozzles at the receiver based on the information concerning the condition signals stored in the storage, and thereafter, control the head to discharge the liquid for recording the image at the recording medium, and in response to receipt of a particular signal, which indicates a potential for receiving the record command, execute a discharging-test process in which the controller controls the discharge-testing device to output the condition signals according to the discharging conditions of the nozzles, and a storing process in which the information concerning the condition signals is stored in the storage.

### BRIEF DESCRIPTION OF DRAWINGS

FIG. 1 is an overall view of a printer.

FIG. 2 is an overall plan view of a recorder.

FIG. 3 is an illustrative view of an electrode located in a cap.

FIG. 4A illustrates a signal output from a signal-processing circuit when a nozzle is functioning regularly. FIG. 4B illustrates a signal output from the signal-processing circuit when the nozzle is discharging an incorrect amount of ink.

FIG. 5 is a block diagram to illustrate an electric configuration of the printer.

FIG. 6 is a flowchart to illustrate a flow of steps to perform a discharge-testing process and an expelling process in the printer.

FIG. 7A is a list of particular signals. FIG. 7B is an illustrative view of an operation screen including a recording-setting icon.

FIG. 8 is a flowchart to illustrate another flow of steps to perform the discharge-testing process and the expelling process in the printer.

FIG. 9 is a flowchart to illustrate another flow of steps to perform the discharge-testing process and the expelling process in the printer.

FIG. 10 is a flowchart to illustrate another flow of steps to perform the discharge-testing process and the expelling process in the printer.

FIG. 11 is a flowchart to illustrate another flow of steps to perform the discharge-testing process and the expelling process in the printer.

FIG. 12 is a flowchart to illustrate a flow of steps to apply or clear a setting as a particular signal in the printer.

FIG. 13A is a flowchart to illustrate a flow of steps to apply or clear settings as particular signals according to preferences entered by a user. FIG. 13B is an illustrative view of a setting screen to set the particular signals.

FIG. 14 is another list of particular signals.

FIG. 15 is an illustrative view of a printer having ink tanks with supply ports.

FIG. 16 is a block diagram to illustrate another electric configuration of the printer.

FIG. 17 is another list of particular signals.

### DESCRIPTION

Hereinafter, an embodiment of the present disclosure will be described with reference to the accompanying drawings.

### Overall Configuration of Printer

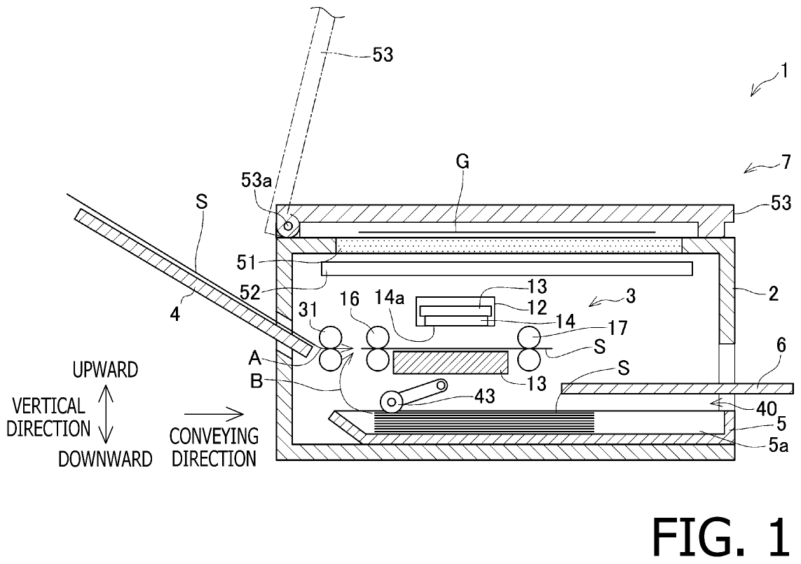

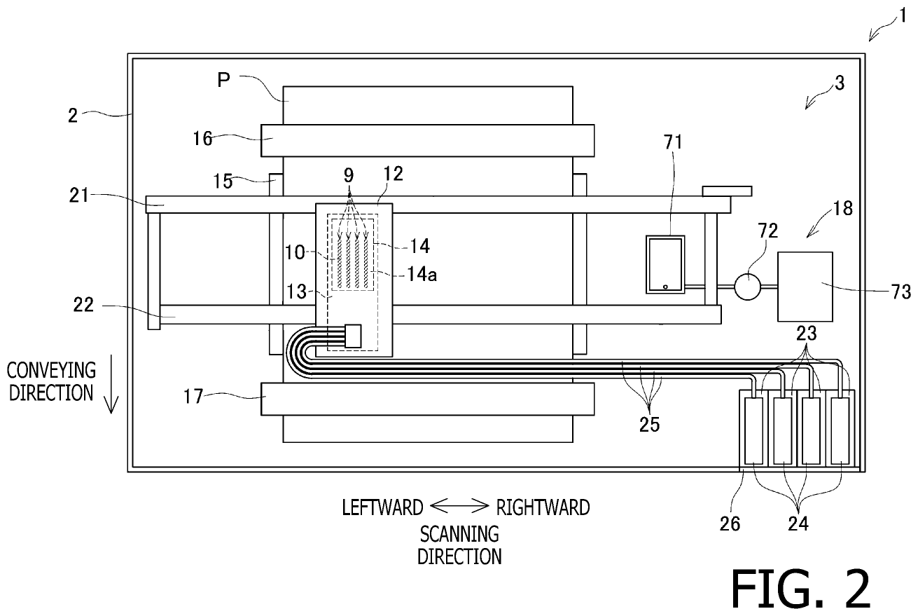

As shown in FIGS. 1 and 2, a printer 1 according to the present embodiment includes a housing 2 in a rectangular parallelepiped form, a recorder 3, a sheet tray 4, a sheet cassette 5, an ejection tray 6, and a scanner 7. The printer 1 is an example of the image recording apparatus.

### Recorder

The recorder 3 is located inside the housing 2 and includes a carriage 12, a sub tank 13, an inkjet head 14, a platen 15, conveyer rollers 16, 17, and a maintenance unit 18. The inkjet head 14 is an example of the head.

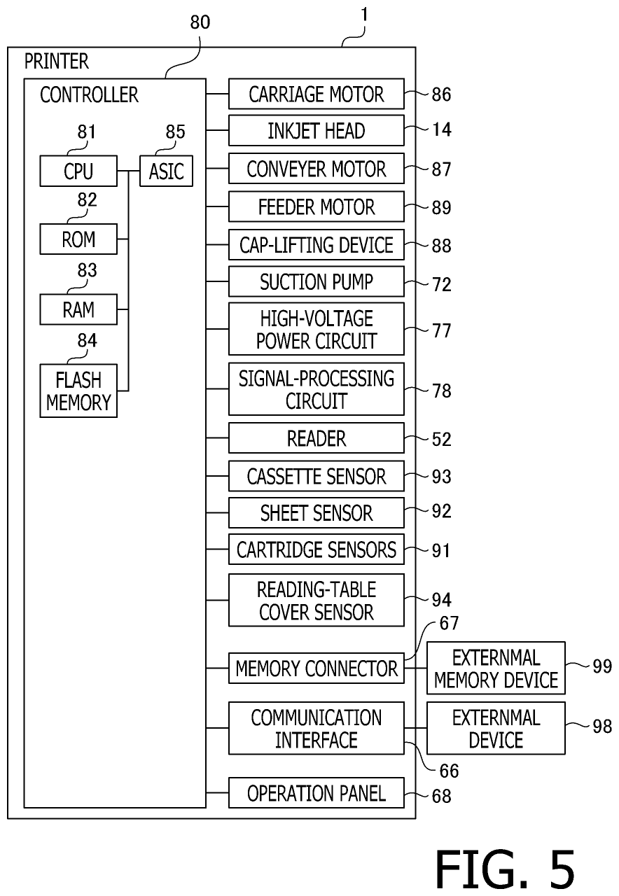

The carriage 12 is supported by two guide rails 21, 22 extending horizontally in a scanning direction. In the context of the present embodiment, directions toward a right-hand side and a left-hand side in FIG. 2 to a viewer are defined as rightward and leftward, respectively. The carriage 12 is connected to a carriage motor 86 (see FIG. 5) through a belt, which is not shown. When the carriage motor 86 is activated, the carriage 12 may move along the guide rails 21, 22 in the scanning direction.

The sub tank 13 is mounted on the carriage 12. In an area in the housing 2 on a right end in the scanning direction and a downstream end in a conveying direction, which is a horizontal direction and intersects orthogonally with the scanning direction, four cartridge-attachable compartments 23 are aligned in the scanning direction. In each of the cartridge-attachable compartments 23, an ink cartridge 24 is detachably attached. In the four ink cartridges 24 attached to the four cartridge-attachable compartments 23, inks in colors of black, yellow, cyan, and magenta may be contained in this given order from right to left in the scanning direction. The four ink cartridges 24 attached to the four cartridge-attachable compartments 23 are connected with the sub tank 13 through four tubes 25, and the inks in the four colors contained in the four ink cartridges 24 may be supplied to the sub tank 13 through the four tubes 25.

The printer 1 includes a cartridge cover 26 attached to the housing 2. The cartridge cover 26 is openable and closable to the overall four cartridge-attachable compartments 23. When the cartridge cover 26 is closed, the four cartridge-attachable compartments 23 are covered. When the cartridge cover 26 is open, the cartridge-attachable compartments 23 are exposed, and the ink cartridges 24 are enabled to be detached from or attached to the cartridge-attachable compartments 23.

The printer 1 includes cartridge sensors 91 (see FIG. 5). The cartridge sensors 91 are provided to the cartridge-attachable compartments 23 in one-to-one correspondence, and each of the cartridge sensors 91 may output a signal indicating whether the ink cartridge 24 is attached to the corresponding one of the cartridge-attachable compartments 23.

The inkjet head 14 is mounted on the carriage 12 and is attached to a lower surface of the sub tank 13. To the inkjet head 14, the inks in the four colors are supplied from the sub tank 13. The inkjet head 14 has a plurality of nozzles 10 formed on a nozzle surface 14a being a lower surface thereof, and the inks supplied from the sub tank 13 may be discharged downward from the nozzles 10. In particular, the plurality of nozzles 10 aligned in lines along the conveying direction form four nozzle rows 9 arrayed along the scanning direction. From the nozzles 10 located in the first, second, third, and fourth positions of the nozzle rows 9 from the right in the scanning direction, the inks may be discharged in the colors of black, yellow, cyan, and magenta, respectively.

The platen 15 is located below the inkjet head 14 and faces the nozzles 10. The platen 15 extends over an entire length of a recording sheet S in the scanning direction and supports the recording sheet S from below. The conveyer roller 16 is located upstream of the inkjet head 14 and the platen 15 in the conveying direction. The conveyer roller 17 is located downstream of the inkjet head 14 and the platen 15 in the conveying direction. The conveyer rollers 16, 17 are connected to a conveyer motor 87 (see FIG. 5) through gears, which are not shown. The recording sheet S is an example of the recording medium.

The maintenance unit 18 includes a cap 71, a suction pump 72, and a waste liquid tank 73. The cap 71 is located rightward in the scanning direction with respect to the platen 15. When the carriage 12 is located at a maintenance position, which is rightward in the scanning direction with respect to the platen 15, the nozzles 10 face the cap 71.

The cap 71 is connected to a cap-lifting device 88 (see FIG. 5). As the cap-lifting device 88 is driven, the cap 71 may move upward or downward. When the carriage 12 is located at the maintenance position, where the nozzles 10 faces the cap 71, and when the cap-lifting device 88 moves the cap 71 upward, an upper end of the cap 71 may fit tightly to the nozzle surface 14a, and the nozzles 10 are in a capped state, in which the nozzles 10 are covered by the cap 71. On the other hand, when the cap 71 is lowered, the nozzles 10 are not covered by the cap 71. However, the cap 71 may not necessarily fit tightly to the nozzle surface 14a to cover the nozzles 10. For example, the cap 71 may fit tightly to a frame (not shown), arranged on a periphery of the nozzle surface 14a of the inkjet head 14 to cover the nozzles 10.

The suction pump 72 is, for example, a tube pump and is connected with the cap 71 and the waste liquid tank 73. The maintenance unit 18 may perform a suction-purge operation for maintenance of the inkjet head 14. In particular, while the nozzles 10 are in the capped state, the suction pump 72 may be activated, and thereby the ink in the inkjet head 14 may be expelled outside the inkjet head 14 through the nozzles 10. The ink expelled from the inkjet head 14 may be collected in the waste liquid tank 73. The cap 71, the suction pump 72, and the waste liquid tank 73 form an example of the expelling device.

The above paragraphs describe, for easier understanding, that the cap 71 may cover all of the nozzles 10 collectively, and the ink in the inkjet head 14 may be expelled through all of the nozzles 10. However, the cap 71 may not necessarily cover all of the nozzles 10 collectively, or the ink in the inkjet head 14 may not necessarily be expelled through all of the nozzles 10. For example, the cap 71 may consist of two separate parts: one for covering the nozzles 10 located in the rightmost nozzle row 9 to discharge the black ink and another for covering the nozzles 10 located in the other three nozzle rows 9 on the left to discharge the colored inks, i.e., the inks in yellow, cyan, and magenta. With the two-parted cap 71, for the suction-purge operation, one of the black ink and the colored inks to be expelled may be selected. For another example, the cap 71 may be provided to each of the nozzle rows 9, and for the suction-purge operation, one of the inks may be selectively expelled from one of the nozzle rows 9.

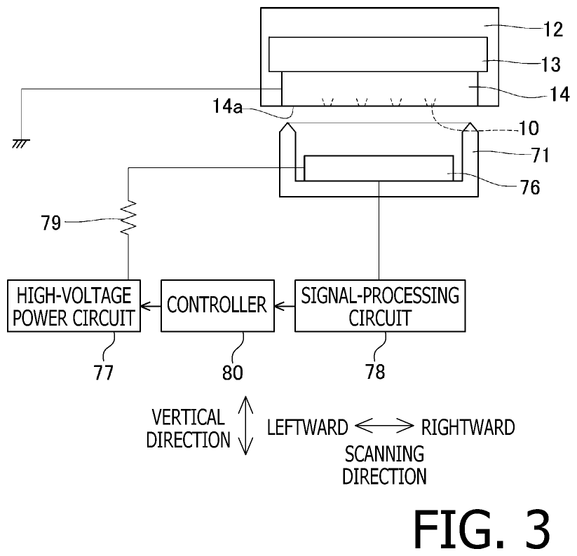

As shown in FIG. 3, an electrode 76 having a form of a rectangular block is located inside the cap 71. The electrode 76 is connected to a high-voltage power circuit 77 through a resistor 79. The high-voltage power circuit 77 may apply a predetermined level of voltage, e.g., 600V, to the electrode 76. Meanwhile, the inkjet head 14 is maintained at a ground potential. Therefore, a potential difference may be created between the inkjet head 14 and the electrode 76. The electrode 76 is connected with a signal-processing circuit 78. The signal-processing circuit 78 may include a differential circuit and may output a signal according to the voltage in the electrode 76. Alternatively, the signal output from the signal-processing circuit 78 may be a current signal.

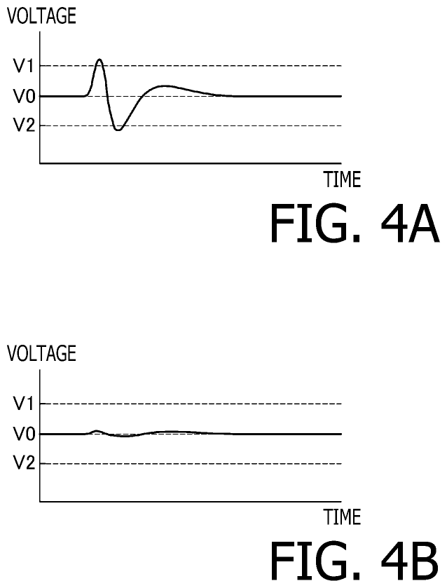

While the nozzles 10 are in the capped state, and while the inkjet head 14 is not driven for testing, when the predetermined level of voltage is applied by the high-voltage power circuit 77 to the electrode 76, the voltage of the signal output from the signal-processing circuit 78 is V0 as shown in FIGS. 4A-4B. The act of driving the inkjet head 14 for testing will be described later.

According to the present embodiment, while the nozzles 10 are in the capped state, when the predetermined level of voltage is applied by the high-voltage power circuit 77 to the electrode 76, the inkjet head 14 may be driven to perform a discharging act, which is an act of discharging the ink from each of the nozzles 10 at the electrode 76.

When the ink is discharged from the nozzle 10 in the discharging act, due to the potential difference between the electrode 76 and the inkjet head 14, the discharged ink is charged. Therefore, the electrical potential of the electrode 76 continuously changes as the charged ink approach the electrode 76 and until the ink lands on the electrode 76. Once the charged ink lands on the electrode 76, the potential of the electrode 76 attenuates and return to the potential at the level before the ink was discharged.

Accordingly, when the ink is discharged from the nozzle 10 in the discharging act correctly, the signal output from the signal-processing circuit 78 may rise from the voltage VO to a level higher than or equal to V1, which is higher than V0, as shown in FIG. 4A, and thereafter, decline to a level lower than a voltage V2, which is lower than the voltage V0. Subsequently, the signal may repeat rising and declining while attenuating gradually and return to the voltage V0.

On the other hand, if the nozzle 10 is malfunctioning, an amount of the ink discharged from the nozzle 10 by the discharging act may be smaller than an amount of the ink discharged from the nozzle 10 functioning correctly. In this case, the signal output from the signal-processing circuit 78 may not change as largely as the signal when the nozzle 10 is functioning correctly but may change within a small range. In this context, the amount of the ink discharged being smaller than the amount of the ink discharged from the nozzle 10 functioning correctly includes no ink being discharged at all. When substantially no ink is discharged from the nozzle 10 by the discharging act, the signal output from the signal-processing circuit 78 may scarcely change.

Thus, according to the present embodiment, the signal output from the signal-processing circuit 78 differs depending on whether the ink is discharged by the discharging act from the nozzle 10 correctly or incorrectly. In other words, the signal output from the signal-processing circuit 78 is a condition signal reflecting a discharging condition of the nozzle 10. Therefore, the signal is used to determine whether the nozzle 10 is a malfunctioning nozzle or a nozzle 10 functioning correctly.

Optionally, the predetermined level of voltage may not necessarily be applied to the electrode 76, the inkjet head 14 may not necessarily be maintained at the ground potential, or the signal-processing circuit 78 may not necessarily output the signal corresponding to the voltage in the electrode 76. For example, the electrode 76 may be maintained at the ground potential and the predetermined level of voltage may be applied to the inkjet head 14 so that the potential difference may be created between the electrode 76 and the inkjet head 14, and the signal-processing circuit 78 may be connected to the inkjet head 14 and may output a signal corresponding to the voltage in the inkjet head 14.

Referring back to FIG. 1, the sheet tray 4 is located on an upstream end of the housing 2 in the conveying direction. The sheet tray 4 inclines to be higher on its upstream end and lower on its downstream end in the conveying direction. A downstream part of the sheet tray 4 in the conveying direction is located inside the housing 2, and the remainder of the sheet tray 4 projects outside the housing 2. On the sheet tray 4, recording sheets S may be placed.

Inside the housing 2, a feeder roller 31 is located between the sheet tray 4 and the conveyer roller 16 in a front-rear direction. The feeder roller 31 is connected with the feeder motor 89 (see FIG. 5) through gears and a switching device, which are not shown. The switching device may connect the feeder motor 89 to one of the feeder roller 31 and a pickup roller 43, which will be described further below, selectively. While the feeder roller 31 is connected with the feeder motor 89, when the feeder motor 89 is activated, the feeder roller 31 may rotate and convey the recording sheet S placed on the sheet tray 4 toward the conveyer roller 16. When a plurality of recording sheets S are stacked on the sheet tray 4, the feeder roller 31 may convey an uppermost one of the recording sheets S on the sheet tray 4 toward the conveyer roller 16.

Further, the printer 1 includes a sheet sensor 92 (see FIG. 5). The sheet sensor 92 is provided to the sheet tray 4 and may output a signal indicating whether the recording sheet S is placed on the sheet tray 4 or not.

### Sheet Cassette

The sheet cassette 5 is detachably attached to a cassette-attachable compartment 40, which is formed in an area lower than the recorder 3 in the housing 2. In particular, the cassette-attachable compartment 40 is open at its downstream end in the conveying direction, and the sheet cassette 5 may be attached to the cassette-attachable compartment 40 by being inserted into the cassette-attachable compartment 40 from the downstream end. On the other hand, the sheet cassette 5 attached to the cassette-attachable compartment 40 may be detached by being pulled out from the downstream end.

The sheet cassette 5 includes a sheet container 5a, which is open upward. In the sheet container 5a, the recording sheets S stacked in a vertical direction may be stored.

The cassette-attachable compartment 40 has the pickup roller 43. The pickup roller 43 is connectable with the feeder motor 89 through gears and the switching device, which are not shown. While the pickup roller 43 is connected with the feeder motor 89, when the feeder motor 89 is activated, the pickup roller 43 may rotate, and an uppermost one of the recording sheets S stored in the sheet container 5a may be conveyed along a conveyer path, as indicated by an arrow B in FIG. 1, to the conveyer roller 16. It may be noted that, in FIG. 1, illustration of parts and members that form the conveyer path are omitted.

Further, the printer 1 includes a cassette sensor 93 (see FIG. 5). The cassette sensor 93 is provided to the cassette-attachable compartment 40 and may output a signal indicating whether the sheet cassette 5 is attached to the cassette-attachable compartment 40 or not.

### Ejection Tray

The ejection tray 6 is located between the conveyer roller 17 and the cassette-attachable compartment 40 in the vertical direction and downstream of the conveyer roller 17 in the conveying direction. The recording sheet S, on which an image is recorded by the recorder 3, may be conveyed by the conveyer rollers 16, 17 in the conveying direction and ejected at the ejection tray 6.

### Scanner

The scanner 7 is located at an upper end of the housing 2. As shown in FIG. 1, the scanner 7 includes a reading table 51, a reader 52, and a reading-table cover 53. The reading table 51 is located at an upper end of the housing 2 and spreads in the scanning direction and the conveying direction. The reading table 51 is formed of a translucent material such as glass. On an upper surface of the reading table 51, an original material G to be read by the reader 52 may be placed.

The reader 52 is located at a position below the reading table 51. The reader 52 has a plurality of reading devices, which are not shown, aligned in the conveying direction. The reader 52 is movable in the scanning direction. The reader 52 may move in the scanning direction and read an image of the original material G placed on the reading table 51 through the plurality of reading devices while moving.

The reading-table cover 53 may cover the reading table 51. The reading-table cover 53 is swingably supported at its upstream end in the conveying direction by a shaft 53a, which extends in the scanning direction. Therefore, the reading-table cover 53 is movable about the shaft 53a between a closed position as drawn in solid lines in FIG. 1, at which the reading-table cover 53 covers the reading table 51, and an open position as drawn in dash-and-dot lines in FIG. 1, at which the reading table 51 is exposed. In the following paragraphs, an act of moving the reading-table cover 53 to the open position may be expressed as “opening the reading-table cover 53,” and act of moving the reading-table cover 53 to the closed position may be expressed as “closing the reading-table cover 53.”

Further, the printer 1 includes a reading-table cover sensor 94 (see FIG. 5). The reading-table cover sensor 94 is provided to the reading-table cover 53 and may output a signal indicating whether the reading-table cover 53 is at the closed position or the open position.

### Electric Configuration of Printer

Next, an electric configuration of the printer 1 will be described. As shown in FIG. 5, the printer 1 includes a controller 80. The controller 80 includes a CPU 81, a ROM 82, a RAM 83, a flash memory 84, and an ASIC 85. CPU is an abbreviation of Central Processing Unit, ROM is an abbreviation of Read Only Memory, RAM is an abbreviation of Random Access Memory, and ASIC is an abbreviation of Application Specific Integrated Circuit. The controller 80 may control devices in the printer 1 including the carriage motor 86, the inkjet head 14, the conveyer motor 87, the cap-lifting device 88, the feeder motor 89, the suction pump 72, the high-voltage power circuit 77, the signal-processing circuit 78, and the reader 52. Furthermore, the controller 80 may receive the signals output from the cartridge sensor 91, the sheet sensor 92, the cassette sensor 93, and the reading-table cover sensor 94.

Moreover, the printer 1 includes an operation panel 68, a memory connector 67, and a communication interface 66. The operation panel 68 is a touch panel arranged on the housing 2 and may display images and information including an operation screen and messages under the control of the controller 80. When a user operates the operation panel 68 according to the images on the operation screen and the messages, signals corresponding to the operation by the user may be transmitted from the operation panel 68 to the controller 80.

The memory connector 67 is connectable with an external memory device 99 through wires or wirelessly. The communication interface 66 establishes communication between the printer 1 and an external device 98. The external device 98 is a device that may transmit a record command commanding the printer 1 to record an image on the recording sheet S to the printer 1 and may be, for example, PC, smartphone, etc. The communication interface 66 is connectable with the external device 98 through wires or wirelessly to communicate with the external device 98. The communication interface 66 may be connected directly with the external device 98 or may be connected to a network, to which the external device 98 is connected, to be connected indirectly with the external device 98 through the network.

Optionally, the controller 8 may have the CPU 81 alone or the ASIC 85 alone to execute various processes or may have the CPU 81 and the ASIC 85 cooperating with each other to execute the processes. Optionally, moreover, the controller 8 may have a single CPU 81 that may execute the processes or may have a plurality of CPUs 81 sharing the processes. Optionally, moreover, the controller 8 may have a single ASIC 85 that may execute the processes or may have a plurality of ASICs 85 sharing the processes.

### Processes for Recording, Discharge-Testing, and Expelling

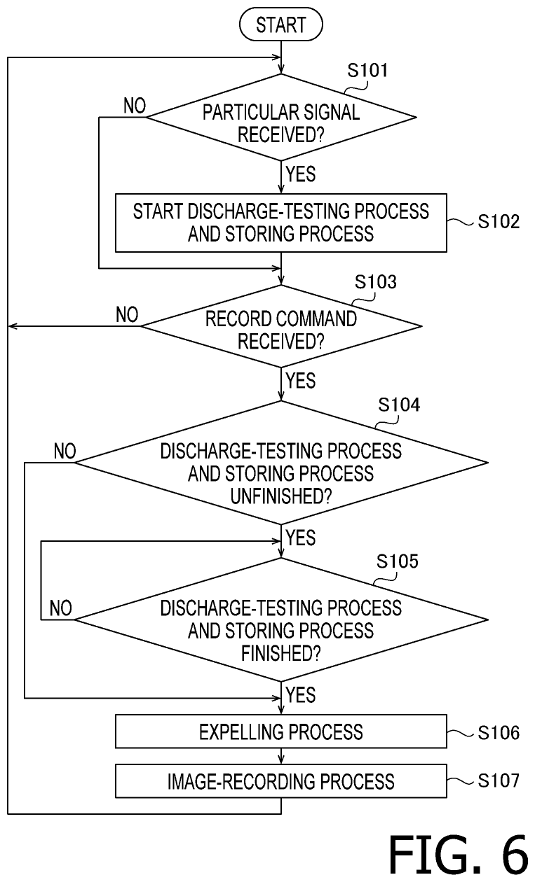

The controller 80 in the printer 1 may execute a process as shown in FIG. 6 while the printer 1 is powered by a commercial power source through, for example, a power plug (not shown).

The flow of steps to be executed in the process will be described herein with reference to FIG. 6. First, the controller 80 determines whether a particular signal is received (S101). The particular signal indicates a potential for receiving a record command, which commands the printer 1 to record an image on a recording sheet S, before receiving the record command. The particular signal will be described further below.

If no particular signal is received (S101: NO), the flow proceeds to S103. If a particular signal is received (S101: YES), the controller 80 starts a discharge-testing process and a storing process (S102) and proceeds to S103. In the discharge-testing process in S102, the controller 80 controls the high-voltage power circuit 77, the carriage motor 86, and the inkjet head 14 to cause the inkjet head 14 to perform the discharging act and the signal-processing circuit 78 to output condition signals. Moreover, in the storing process in S102, the controller 80 collects and stores information concerning the condition signals output from the signal-processing circuit 78 in the discharge-testing process in the flash memory 84. The information concerning the condition signals may be information of the conditions of the nozzles 10 indicated by the condition signals or may be information based on the conditions of the nozzles 10 indicated by the condition signals and indicating whether an expelling process to perform an expelling act is necessary. The expelling process and the expelling act will be described further below.

In S103, the controller 80 determines whether a record command is received. If no record command is received (S103: NO), the flow returns to S101. If a record command is received (S103: YES), the controller 80 determines whether the discharge-testing process and the storing process are in midstream or unfinished (S104). If neither the discharge-testing process nor the storing process is in midstream (S104: NO), the flow proceeds to S106. If the discharge-testing process and/or the storing process are in midstream (S104: YES), the controller 80 waits until the discharge-testing process and the storing process are finished (S105: NO), and when the discharge-testing process and the storing process are finished (S105: YES), the flow proceeds to S106.

In S106, the controller 80 executes the expelling process. In the expelling process in S106, the controller 80 controls the carriage motor 86, the cap-lifting device 88, and the suction pump 72 to perform a suction-purging act or controls the carriage motor 86 and the inkjet head 14 to perform a flushing act, by which the ink may be expelled from the nozzles 10 at the cap 71, based on the condition information stored in the flash memory 84.

For example, when the condition information stored in the flash memory 84 indicates that a number of malfunctioning nozzles 10 is smaller than a threshold number, in the expelling process in S106, the controller 80 may control the carriage motor 86, the cap-lifting device 88, and the suction pump 72 to perform a first suction-purging act. For another example, when the condition information stored in the flash memory 84 indicates that the number of malfunctioning nozzles 10 is greater than or equal to the threshold number, in the expelling process in S106, the controller 80 may control the carriage motor 86, the cap-lifting device 88, and the suction pump 72 to perform a second suction-purging act, in which an amount of the ink to be expelled is greater than an amount of the ink to be expelled in the first suction-purging act. In the second suction-purging act, for example, a length of time to drive the suction pump 72 may be longer than a length of time to drive the suction pump 72 in the first suction-purging act. For another example, in the second suction-purging act, a rotation speed of the suction pump 72 may be higher than a rotation speed of the suction pump 72 in the first suction-purging act. For another example, in the second suction-purging act, the length of time to drive the suction pump 72 may be longer than the length of time to drive the suction pump 72 in the first suction-purging act, and the rotation speed of the suction pump 72 may be higher than the rotation speed of the suction pump 72 in the first suction-purging act.

For another example, the controller 80 may control the carriage motor 86, the cap-lifting device 88, and the suction pump 72 in the expelling process in S106 to perform the suction-purging act when the condition information stored in the flash memory 84 indicates necessity of executing the suction-purging act.

For another example, when the condition information stored in the flash memory 84 indicates malfunctioning of the nozzles 10, the controller 80 may control the carriage motor 86, the cap-lifting device 88, and the suction pump 72 in the expelling process in S106 to perform a flushing act for expelling the ink from the nozzles 10.

For another example, when the condition information stored in the flash memory 84 indicates that a number of malfunctioning nozzles 10 is smaller than a threshold number, in the expelling process in S106, the controller 80 may control the carriage motor 86 and the inkjet head 14 to perform a flushing act for expelling the ink from the nozzles 10 that are specified in the condition information stored in the flash memory 84 as malfunctioning nozzles 10. On the other hand, when the condition information stored in the flash memory 84 indicates that a number of malfunctioning nozzles 10 is greater than or equal to the threshold number, the controller 80 may control the carriage motor 86, the cap-lifting device 88, and the suction pump 72 in the expelling process in S106 to perform the suction-purging act.

In the present embodiment, the cap 71 that may receive the ink expelled from the nozzles 10 during the flushing act is an example of the receiver. Optionally, a single-purposed receiver for receiving the ink from the nozzles 10 specifically for the flushing act may be provided separately from the cap 71.

In the paragraphs below, the suction-purging act and the flushing act performed in S106 may be collectively called the expelling act. Moreover, the expelling act may include controlling the carriage motor 86, the cap-lifting device 88, the suction pump 72, and the inkjet head 14 to perform neither the suction-purging act nor the flushing act when, for example, the condition information indicates there is no malfunctioning nozzles 10 or no necessity to perform the suction-purging act.

Following the expelling process in S106, the controller 80 executes an image-recording process (S107). In the image-recording process in S107, in particular, the controller 80 controls the feeder motor 89 to cause the feeder roller 31 to feed the recording sheet S from the sheet tray 4 to the conveyer roller 16 or to cause the pickup roller 43 to feed the recording sheet S from the sheet cassette 5 to the conveyer roller 16. Further, the controller 80 controls the conveyer motor 87 to convey the recording sheet S to a position where the recording sheet S faces the nozzle surface 14a. Furthermore, the controller 80 controls the printer 1 to record an image by repeating a recording pass, in which the controller 80 controls the carriage motor 86 to move the carriage 12 in the scanning direction and the inkjet head 14 to discharge the ink through the nozzles 10, and a conveying act, in which the controller 80 controls the conveyer motor 87 to rotate the conveyer rollers 16, 17 to convey the recording sheet S. Moreover, the controller 80 controls the conveyer motor 87 to rotate the conveyer rollers 16, 17 to eject the recording sheet S, on which the image is recorded, at the ejection tray 6. After the image-recording process in S107, the flow returns to S101.

### Particular Signals

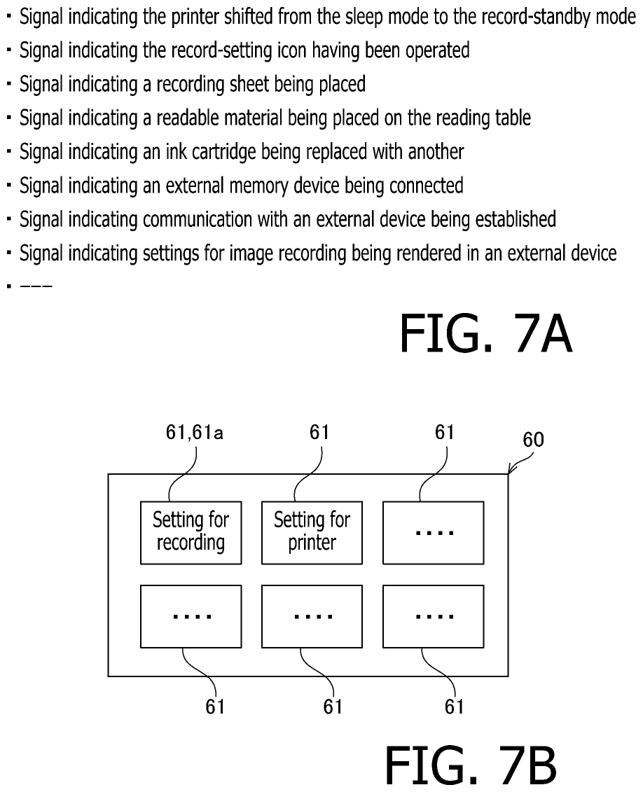

Next, the particular signals will be described below. In the present embodiment, information of the particular signals as listed in FIG. 7A are stored in the flash memory 84. The signals listed in FIG. 7A will be described below.

The printer 1, when not recording an image, may stay in one of a record-standby mode and a sleep mode. The record-standby mode is a mode, in which electric power is supplied to the entire devices in the printer 1, and the printer 1 is ready to start recording an image on a recording sheet S shortly. The sleep mode is a mode, in which power supply to some of the devices, such as sensors and motors, is suspended in order to save power consumption. In order to start recording an image on a recording sheet S from the sleep mode, the power supply to the suspended devices such as the sensors and the motors needs to be resumed, and the printer 1 needs to exit the sleep mode and shift to the record-standby mode. Therefore, the printer 1 in the sleep mode takes a longer time to start recording an image on the recording sheet S than the time taken by the printer 1 in the record-standby mode. The printer 1 may shift from the sleep mode to the record-standby mode when, for example, a predetermined operation is rendered by a user through the operation panel 68 while the printer 1 is in the sleep mode. “Signal indicating the printer 1 shifted from the sleep mode to the record-standby mode” listed in FIG. 7A may be, for example, a signal that the controller 80 may receive in response to the predetermined operation rendered by the user through the operation panel 68 while the printer 1 is in the sleep mode.

Meanwhile, the printer 1 may display an operation screen 60 as shown in FIG. 7B in the operation panel 68. The operation screen 60 has an area, in which a plurality of icons 61 are displayed. The plurality of icons 61 include a record-setting icon 61a, through which settings for recording of an image may be entered. “Signal indicating the record-setting icon having been operated” listed in FIG. 7A is a signal that may be output from the operation panel 68 when the user operates the record-setting icon 61a. The user operating an icon 61 may mean, for example, the user touched an area in the operation panel 68 occupied by one of the icons 61 while the icons 61 are displayed in the operation panel 68. The area in which the icons 61 are displayed in the operation panel 68 is an example of icon-display area. “Signal indicating a recording sheet being placed” listed in FIG. 7A includes a signal that may be output from the sheet sensor 92 when the recording sheet S is placed on the sheet tray 4 and a signal that may be output from the cassette sensor 93 when the sheet cassette 5 is attached to the cassette-attachable compartment 40.

“Signal indicating a readable material being placed on the reading table” listed in FIG. 7A includes a signal that may be output from the reading-table cover sensor 94 when the reading-table cover 53 is opened and a signal that may be output from reading-table cover sensor 94 when the reading-table cover 53 is closed. Optionally, the signal indicating a readable material being placed on the reading table may include a signal to be output from a sensor that may directly detect presence of the original material placed on the reading table.

“Signal indicating an ink cartridge being replaced” listed in FIG. 7A includes a signal that may be output from the cartridge sensor 91 when the cartridge-attachable compartment 23 is loaded with an ink cartridge 24. Optionally, the signal indicating an ink cartridge being replaced may include a signal that may be output from the cartridge sensor 91 when the cartridge-attachable compartment 23 is unloaded with the ink cartridge 24.

“Signal indicating an external memory device being connected” listed in FIG. 7A means a signal that may be output from the memory connector 67 when an external memory device 99 is connected to the memory connector 67.

“Signal indicating communication with an external device being established” means a signal that may be output from the communication interface 66 when the communication interface 66 is connected with the external device 98 directly or indirectly through a network.

According to the present embodiment, the external device 98, which is connectable to the communication interface 66, has a pre-installed application program to enable the external device 98 to transmit, to the printer 1, the record command for commanding the printer 1 to perform image recording and a plurality of types of signals including at least signals for applying settings in the image recording. “Signal indicating settings for image recording being rendered in an external device” listed in FIG. 7A refers to signals that may be output from the external device 98 to the printer 1 when an operation for applying settings concerning recording of an image is rendered through an operation interface (not shown) in the external device 98 and the application program processes the operation.

### Effects

According to the present embodiment, when the controller 80 receives the particular signal indicating the potential for receiving a record command, the controller 80 may execute the discharge-testing process and the storing process. Thereafter, when the record command is received in actuality, the controller 80 may control the carriage motor 86, the cap-lifting device 88, the suction pump 72, and the inkjet head 14 to perform the expelling act based on the information concerning the condition signals stored in the flash memory 84 and thereafter control the inkjet head 14 and the carriage motor 86 to record an image on the recording sheet S. Accordingly, the expelling act may be performed based on the conditions of the nozzles 10 in the inkjet head 14 shortly before the image is recorded on the recording sheet S. Moreover, according to the present embodiment, a time period from the time when the controller 80 receives the record command to the time when the printer 1 starts recording of the image on the recording sheet S may be shortened compared to the case, in which, when a record command is received, the discharge-testing process and the storing process are performed, the expelling act is performed, and then an image is recorded on a recording sheet S.

According to the present embodiment, moreover, when a record command is received during the discharge-testing process and the storing process, the controller 80 may control the printer 1 to perform the expelling act and thereafter an image may be recorded on the recording sheet S. According to this flow, the image may be recorded on the recording sheet S after the conditions of the nozzles 10 are recovered or improved.

When an operation to cause the printer 1 to shift from the sleep mode to the record-standby mode is rendered by the user, it is likely that the controller 80 thereafter receives a record command. Therefore, according to the present embodiment, a signal that the controller 80 receives when the printer 1 shifts from the sleep mode to the record-standby mode is determined to be the particular signal.

When the user operates the record-setting icon 61a, which is related to settings for recording of an image on the recording sheet S, it is likely that the controller 80 thereafter receives a record command. Therefore, according to the present embodiment, a signal that the controller 80 receives when the record-setting icon 61a is operated is determined to be the particular signal.

When the recording sheet S is placed on the sheet tray 4, or when the sheet cassette 5 is attached to the cassette-attachable compartment 40, it is likely that the controller 80 thereafter receives a record command. Therefore, according to the present embodiment, the signal output from the sheet sensor 92 indicating that the recording sheet S is placed on the sheet tray 4 and the signal output from the cassette sensor 93 indicating that the sheet cassette 5 is attached to the cassette-attachable compartment 40 are determined to be the particular signals.

When the original material G is placed on the reading table 51, it is likely the reader 52 is thereafter operated to read an image of the original material G placed on the reading table 51 and the recorder 3 is operated to record an image on the recording sheet S based on the outcome of the image read by the reader 52. In other words, it is likely that the controller 80 receives a record command after the original material G is placed on the reading table 51. Moreover, for placing the original material G on the reading table 51, the reading-table cover 53 is opened and closed. Therefore, according to the present embodiment, the signal output from the reading-table cover sensor 94 indicating that the original material G is placed on the reading table 51 is determined to be the particular signal.

When the ink cartridge 24 in the printer 1 is replaced with another ink cartridge 24, it is likely that the controller 80 thereafter receives a record command. Therefore, according to the present embodiment, the signal output from the cartridge sensor 91 indicating that the ink cartridge 24 is attached to or detached from the cartridge-attachable compartment 23 is determined to be the particular signal.

When the external memory device 99 is attached to the memory connector 67 in the printer 1, it is likely that the controller 80 thereafter receives a record command commanding the printer 1 to record an image on the recording sheet S based on the image data stored in the external memory device 99. Therefore, according to the present embodiment, the signal indicating the external memory device 99 being connected to the memory connector 67 is determined to be the particular signal.

When the external device 98 is directly connected to the printer 1, and communication is established between the external device 98 and the printer 1, the external device 98 is enabled to communicate with the printer 1, and it is likely that the controller 80 thereafter receives a record command from the external device 98. Therefore, according to the present embodiment, the signal indicating that communication with the external device 98 is established is determined to be the particular signal.

When the external device 98 is connected to the same network, to which the printer 1 is connected, and is enabled to communicate with the printer 1, it is likely that a record command may be transmitted thereafter from the external device 98 to the printer 1. Therefore, according to the present embodiment, the signal indicating that the external device 98 is connected to the same network as the network to which printer 1 is connected and is enabled to communicate with the printer 1 is determined to be the particular signal.

While the printer 1 and the external device 98 are connected and are able to communicate with each other, when an operation for applying settings in the printer 1 for recording an image on the recording sheet S is rendered through the operation interface of the external device 98, it is likely that the record command is thereafter transmitted from the external device 98 to the printer 1. Therefore, according to the present embodiment, a signal transmitted from the external device 98 to the printer while the printer 1 and the external device 98 are connected and able to communicate with each other and when an operation for applying settings for the printer 1 to record an image on the recording sheet S is rendered through the operation interface of the external device 98 is determined to be the particular signal.

### More Examples

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

For example, the discharge-testing process and the storing process may not necessarily be executed each time the controller 80 receives the particular signal, or the expelling process before the image-recording process may not necessarily be executed each time the controller 80 receives the record command.

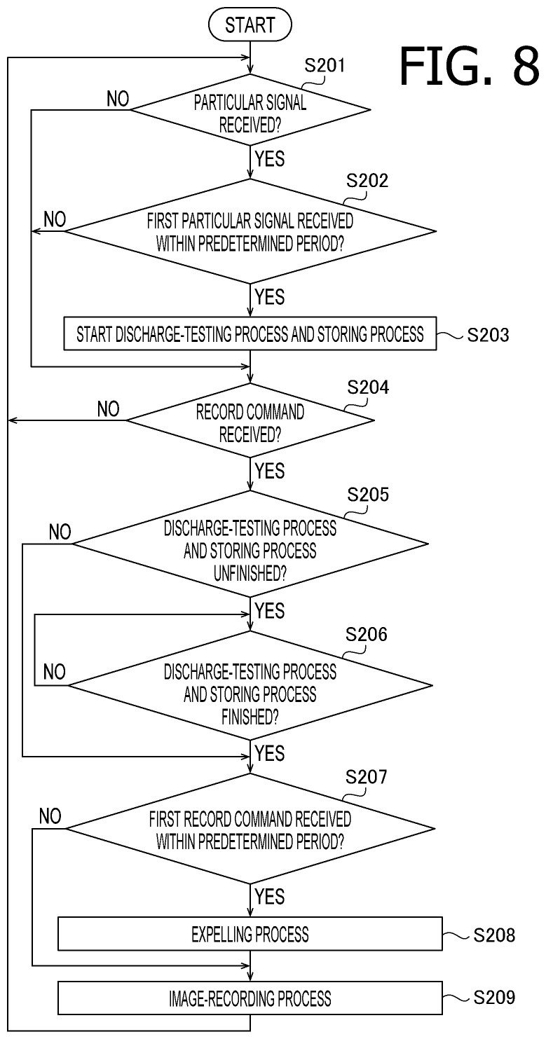

A first modified example will be described below. In the printer 1 according to the first modified example, the controller 80 executes a process as shown in FIG. 8. First, the controller 80 determines whether the particular signal is received (S201), similarly to S101 (see FIG. 6) in the embodiment described above. If no particular signal is received (S201: NO), the flow proceeds to S204. If a particular signal is received (S201: YES), the controller 80 determines whether the particular signal is a first particular signal received within a predetermined time period (S202). The predetermined period in this context regarding S202 may be, for example, a day, a period between 5 a.m. in one day and 5 a.m. in the next day, etc. Optionally, the predetermined period may be two days, a few hours, etc.

If the particular signal is a second or subsequent particular signal received within the predetermined period (S202: NO), the flow proceeds to S204. If the particular signal is the first particular signal received within the predetermined period (S202: YES), the controller 80 executes the discharge-testing process and the storing process similarly to S102 (see FIG. 6) in the embodiment described above. The flow proceeds to S204.

In S204, the controller 80 determines whether a record command is received, similarly to S103 (see FIG. 6) in the embodiment described above. If no record command is received (S204: NO), the flow returns to S201. If a record command is received (S204: YES), the controller 80 determines whether the discharge-testing process and the storing process are unfinished and in midstream (S205). If neither the discharge-testing process nor the storing process is in midstream (S205: NO), the flow proceeds to S207. If the discharge-testing process and the storing process are in midstream (S205: YES), the controller 80 waits until the discharge-testing process and the storing process are finished (S206: NO), and when the discharge-testing process and the storing process are finished (S206: YES), the flow proceeds to S207.

In S207, the controller 80 determines whether the record command is a first record command received within a predetermined period (S207). The predetermined period in the context regarding S207 may be, for example, a day, a period between 5 a.m. in one day and 5 a.m. in the next day, etc. Optionally, the predetermined period may be two days, a few hours, etc. Optionally, the predetermined period regarding S202 and the predetermined period regarding S207 may or may not be equal.

If the record command is the first record command received within the predetermined period (S207: YES), the controller 80 executes the expelling process (S208) similarly to the expelling process in S106 (see FIG. 6) in the embodiment described above and executes the image-recording process (S209) similarly to the image-recording process in S107 (see FIG. 6) in the embodiment described above. The flow returns to S201.

If the record command is a second or subsequent record command received within the predetermined period (S207: NO), the controller 80 executes the image-recording process (S209) without conducing the expelling process. The flow returns to S201.

According to the first modified example, when the controller 80 receives the particular signal, and if the received particular signal is the first particular signal received within the predetermined period, the controller 80 executes the discharge-testing process and the storing process, but if the received particular signal is the second or subsequent particular signal received within the predetermined period, the controller 80 does not execute the discharge-testing process or the storing process. Therefore, the discharge-testing process and the storing process may not be executed unnecessarily within the predetermined period, and wasteful consumption of the ink may be reduced.

According to the first modified example, when the controller 80 receives the record command, and if the received record command is the first record command received within the predetermined period, the controller 80 controls the printer 1 to perform the expelling act and thereafter the image-recording act, but if the received record command is a second or subsequent record command received within the predetermined period, the controller 80 controls the printer 1 to perform the image-recording act without performing the expelling act. Accordingly, the expelling act may not be performed unnecessarily within the predetermined period, and wasteful consumption of the ink may be reduced.

Meanwhile, the discharge-testing process and the storing process may not be necessarily executed depending on whether the particular signal is the first particular signal received within the predetermined period, or the expelling process may not be necessarily executed depending on whether the record command is the first record command received within the predetermined period. For example, while the discharge-testing process and the storing process may be executed depending on whether the particular signal is the first predetermine signal received in the predetermined period, the expelling process may be executed each time when the record command is received. For another example, while the discharge-testing process and the storing process may be executed each time the particular signal is received, the expelling process may be executed depending on whether the record command is the first record command received within the predetermined period.

For another example, if the record command is received while the discharge-testing process and the storing process are in midstream, the image-recording process may not necessarily be executed after the discharge-testing process and the storing process are finished and after the expelling process is executed. In this regard, a second modified example will be described below.

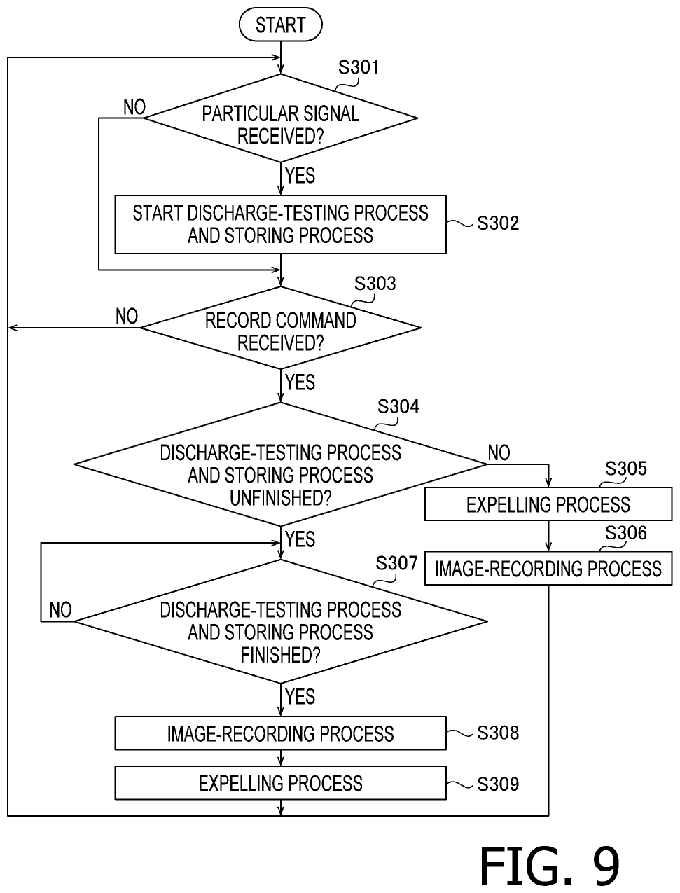

In the printer 1 according to the second modified example, the controller 80 may execute a process shown in FIG. 9. In particular, the controller 80 executes S301-S304, which are substantially equal to S101-S104 (see FIG. 6) in the embodiment described above. In S304, if the discharge-testing process and the storing process are not in midstream (S304: NO), the controller 80 executes the expelling process (S305) and the image-recording process (S306), similarly to the expelling process in S106 (see FIG. 6) and the image-recording process in S107 (see FIG. 6). The flow returns to S301.

In S304, if the discharge-testing process and/or the storing process are unfinished and in midstream (S304: YES), the controller 80 waits until the discharge-testing process and the storing process are finished (S307: NO), and when the discharge-testing process and the storing process are finished (S307: YES), the controller 80 executes the image-recording process (S308) and thereafter the expelling process (S309) in a reversed order from S106-S107 (see FIG. 6) in the embodiment described above. The flow returns to S301.

According to the second modified example, while the discharge-testing process and the storing process are in midstream, when a record command is received, after the discharge-testing process and the storing process are finished, the controller 80 controls the printer 1 to perform the image-recording act without performing the expelling act. In this arrangement, after the discharge-testing process and the storing process, without performing the expelling act, a time period from the time when the record command is received to the time when recording of the image on the recording sheet S starts may be shortened.

According to the second modified example, moreover, the expelling act may be performed after recording of the image on the recording sheet S is finished. Therefore, the conditions of the nozzles 10 may recover based on the outcome of the discharge-testing process which was executed most recently before the image is recorded on the recording sheet S.

Meanwhile, when a record command is received while the discharge-testing process and the storing process are in midstream, the expelling process may not necessarily be executed after the discharge-testing process and the storing process are finished and after the image-recording process is finished. For example, when a record command is received while the discharge-testing process and the storing process are in midstream (S304: YES), the flow may proceed to S307 to finish the discharge-testing process and the storing process (S307: YES), and to S308 to finish the image-recording process (S308), and thereafter may return to S301.

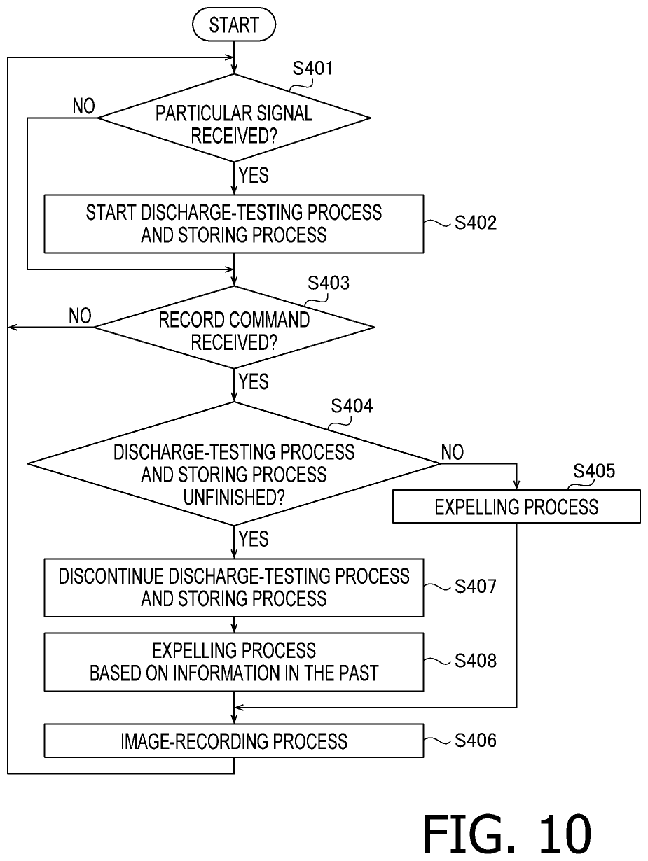

A third modified example will be described below. In the printer 1 according to the third modified example, the controller 80 executes a process as shown in FIG. 10. In particular, the controller 80 executes S401-S404, which are substantially equal to S101-S104 (see FIG. 6) in the embodiment described earlier. In S404, if the discharge-testing process and the storing process are not in midstream (S404: NO), the controller 50 executes the expelling process (S405) and the image-recording process (S406), which are substantially equal to the expelling process in S106 and the image-recording process in S107. The flow returns to S401.

In S404, if the discharge-testing process and/or the storing process are unfinished and in midstream (S404: YES), the controller 80 discontinues the discharge-testing process and the storing process (S407) and executes the expelling process (S408) based on information concerning condition signals stored in the flash memory 84 in an earlier storing process executed before the currently discontinued storing process. Thereafter, the controller 80 executes the image-recording process (S406), and the flow returns to S401.

According to the third modified example, while the discharge-testing process and the storing process are in midstream, when a record command is received, the discharge-testing process and the storing process are discontinued, and the expelling act may be performed based on the information concerning the condition signals stored in the flash memory 84 earlier, and the image may be recorded on the recording sheet S. Therefore, the time period from the time when the record command is received to the time when recording of the image on the recording sheet S starts may be shortened. Meanwhile, the conditions of the nozzles 10 may be recovered by the expelling act according to the information concerning the earlier condition signals before recording of the image on the recording sheet S starts.

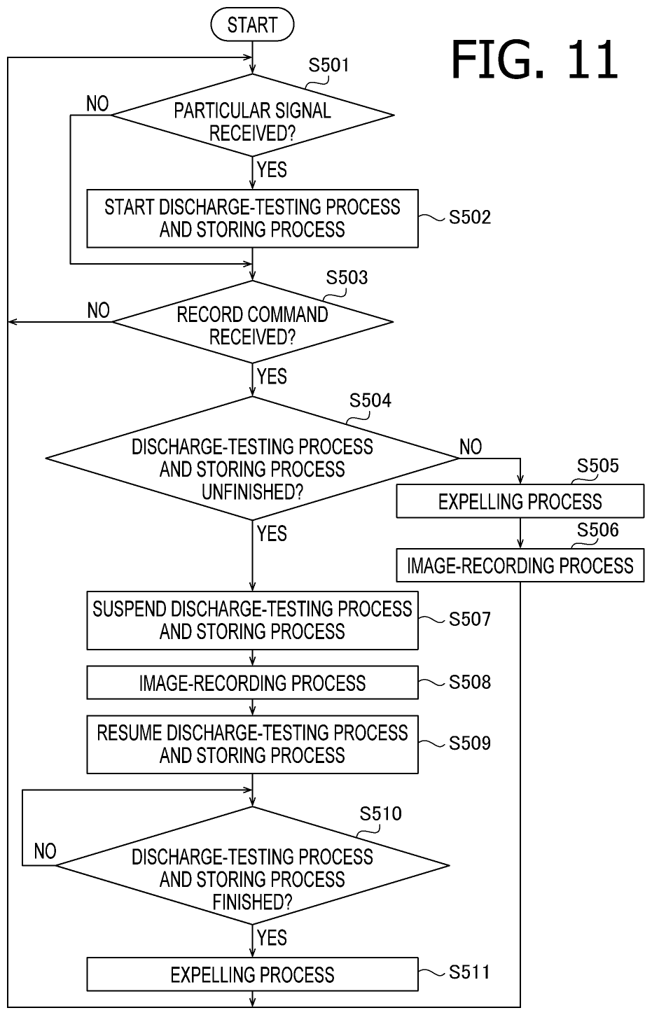

A fourth modified example will be described below. In the printer 1 according to the fourth modified example, the controller 80 executes a process as shown in FIG. 11. In particular, the controller 80 executes S501-S504, which are substantially equal to S101-S104 (see FIG. 6) in the embodiment described earlier. In S504, if the discharge-testing process and the storing process are not in midstream (S504: NO), the controller 50 executes the expelling process (S505) and the image-recording process (S506), which are substantially equal to the expelling process in S106 and the image-recording process in S107. The flow returns to S501.

In S504, if the discharge-testing process and/or the storing process are unfinished and in midstream (S504: YES), the controller 80 suspends the discharge-testing process and the storing process (S507) and executes the image-recording process (S508). After the image-recording process, the controller 80 resumes the discharge-testing process and the storing process (S509) and waits until the discharge-testing process and the storing process are finished (S510: NO), and when the discharge-testing process and the storing process are finished (S510: YES), the controller 80 executes the expelling process (S511), and the flow returns to S501.

According to the fourth modified example, while the discharge-testing process and the storing process are in midstream, when the record command is received, the discharge-testing process and the storing process are suspended, and the image is recorded on the recording sheet S without performing the expelling act. Therefore, the time period from the time when the record command is received to the time when recording of the image on the recording sheet S starts may be shortened.

Moreover, according to the fourth modified example, after the image is recorded on the recording sheet S, the discharge-testing process and the storing process having been suspended are resumed, and thereafter, the expelling act is performed. Thus, the conditions of the nozzles 10 may recover.

According to the fourth modified example, while the discharge-testing process and the storing process are in midstream, when the record command is received, the discharge-testing process and the storing process are suspended, the image is recorded on the recording sheet S, the discharge-testing process and the storing process is resumed, and thereafter the expelling act is performed. Optionally, however, while the discharge-testing process and the storing process are in midstream, when the record command is received, the discharge-testing process and the storing process may be suspended, the image may be recorded on the recording sheet S, the discharge-testing process and the storing process may be resumed, and thereafter the flow may return to S501 without executing the expelling process.

For another example, applying and clearing of the settings as the particular signals may be controlled by the controller 80. In this regard, a fifth modified example will be described below.

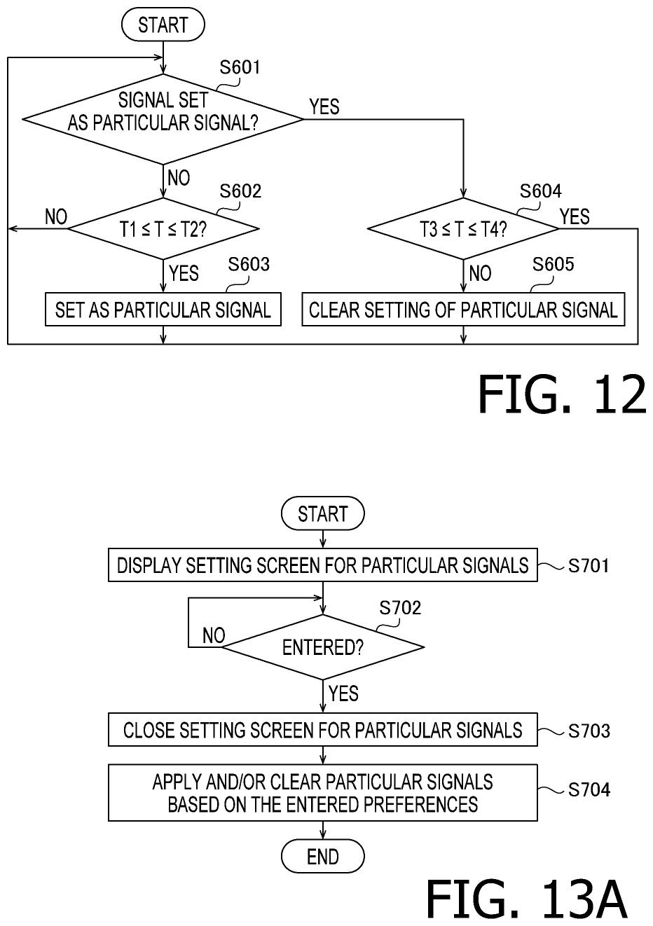

The controller 80 according to the fifth modified example stores time periods, each of which is a time period concerning each of the signals listed in FIG. 7A, in, for example, the flash memory 84. In particular, each of the time periods is a time period from the time when the controller 80 may receive the signal to a time when the controller 80 may receive a record command thereafter. The controller 80 may execute a process as shown in FIG. 12 for each of the received signals listed in FIG. 7A while the printer 1 is powered.

Optionally, in the fifth modified example, by the time when the printer 1 is used initially, not all of the signals listed in FIG. 7A may necessarily be set as the particular signals, none of the signals listed in FIG. 7A may necessarily be set as the particular signals, or some of the signals listed in FIG. 7A may not necessarily be set as the particular signals while the other of the signals listed in FIG. 7A may be set as the particular signals.

In the printer 1 according to the fifth modified example, the controller 80 executes a process as shown in FIG. 12. In particular, if the received signal is not set as the particular signal (S601: NO), the controller 80 determines whether an average time T of the signal, which is an average of time periods each from when the signal is received to when a following record command is received, falls within a range from a time T1 to a time T2, inclusive (S602). If the average time T does not fall within the range from the time T1 to the time T2, inclusive (S602: NO), the flow returns to S601. If the average time T falls within the range from the time T1 to the time T2, inclusive (S602: YES), the controller 80 sets the received signal as the particular signal (S603: YES), and the flow returns to S601.

If the received signal is set as the particular signal (S601: YES), the controller 80 determines whether the average time T of the signal falls within a range from a time T3 to a time T4, inclusive (S604). If the average time T of the signal does not fall within the range from the time T3 to the time T4, inclusive (S604: NO), the controller 80 clears the setting of the received signal as the particular signal, in other words, determines that the received signal is not the particular signal (S605), and the flow returns to S601. If the average time T of the signal falls within the range from the time T3 to the time T4, inclusive (S604: YES), the flow returns to S601.

In the fifth modified example, the average time T of a received signal falling within the range from the time T1 to the time T2, inclusive, satisfies a condition for setting a signal as the particular signal, and the average time T shorter than the time T3 or longer than the time T4 satisfies another condition for clearing the setting as the particular signal from the signal. In the fifth modified example, the range from the time T1 to the time T2, inclusive, and the range from the time T3 and to the time T4, inclusive, may or may not be the same range. In other words, the former condition and the latter condition may or may not be the same condition.

If the setting as the particular signal is applied to a signal having an excessively long time period from the time when the signal is received to the time when the following record command is received, the conditions of the nozzles 10 may change during a period of time after the discharge-testing process and the storing process are executed and by the time when the record command is received. In this case, the expelling act to be performed based on receipt of the record command may not suit the recent conditions of the nozzles 10. On the other hand, if the setting as the predetermined signal is applied to a signal having an excessively short time period from the time when the signal is received to the time when the following record command is received, the following record command may be received with high frequency during the discharge-testing process and the storing process.

Therefore, according to the fifth modified example, the lengths of the time from when each of the signals listed in FIG. 7A was received to when the following record command was received in the past transactions are collected in the flash memory 84. Based on the collected time lengths, the signals, of which average time T being the average of the collected time lengths is greater than or equal to the time T1 and smaller than or equal to T2, are set as the particular signals. Thus, the settings as the particular signals may be applied to the suitable signals.

According to the fifth modified example, for each of the signals that are set as the particular signals, the lengths of the time from the time when the signals were received to the following record commands were received in the past transactions are collected in the flash memory 84. Among those, the signals, of which average time T achieved from the collected time lengths is neither greater than or equal to the time T3 nor smaller than or equal to the time T4, are excluded from the particular signals. Thus, the settings of the signals that are once set as the particular signals may be cleared when the signals are no longer suitable to be the particular signals.

In the fifth modified example, in S602, optionally, the received signal may be set as the particular signal as long as the average time T of the signal is greater than or equal to the time T1, regardless of whether the average time T of the signal is smaller than or equal to or greater than the time T2. Moreover, in S604 in the fifth modified example, optionally, the setting as the particular signal applied to the received signal may be cleared as long as the average time T of the signal is smaller than the time T3, and the setting of the received signal as the particular signal may be maintained as long as the average time T of the signal is greater than or equal to the time T3, even when the average time T of the signal is greater than the time T4. According to these arrangements, a signal, of which length of time from the time when the signal is received to the time when the following record command is received is short, may be prevented from being set as the particular signal. In other words, signals, which are likely to be received when the user tends to command the printer 1 to record an image shortly, may be excluded from the particular signals, and the signals that may provide adequate lengths of time from the time when signal is received to the time when the following record command is received may be exclusively set as the particular signals.

Optionally, the settings of the signals as the particular signals may not necessarily be applied or cleared based on the determination whether the average time T falls within the predetermined range. For example, the setting of the signal as the particular signal may be applied or cleared based on a value of another parameter related to the length of the time from the time when the signal is received to the time when the following record command is received. Such another parameter may be, for example, a number of times the record commands are received within a predetermined time period after the signals are received, and a percentage of the number of times the record commands are received within the predetermined time period after the signals are received over a number of times the overall record commands are received. In these arrangements, the settings of the signals may be applied or cleared based on a determination whether the value of the parameter falls within the predetermined range or not or based on a determination whether the value of the parameter satisfies a condition other than falling within the predetermined range or not.

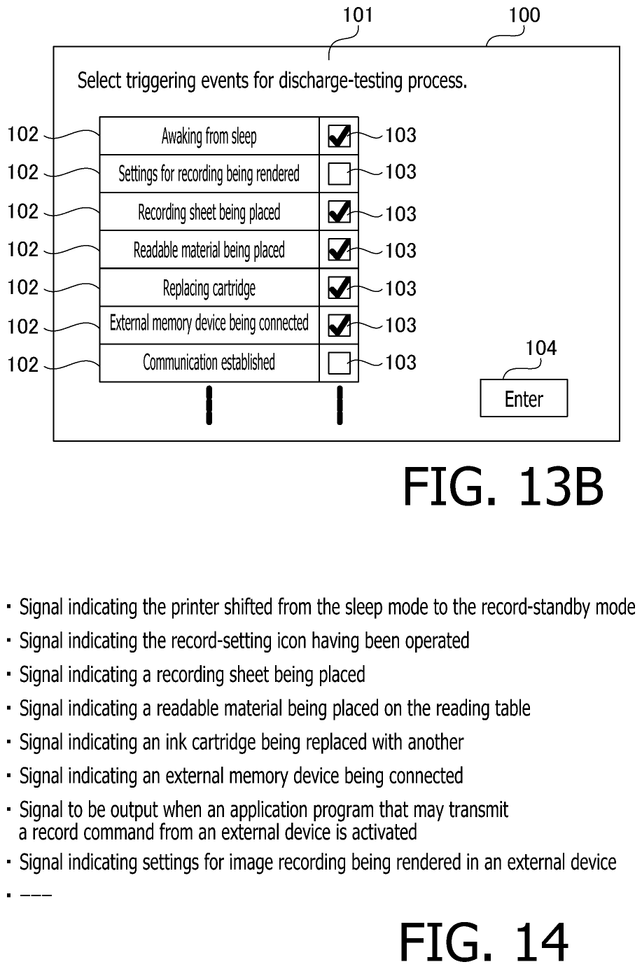

Optionally, the settings of the particular signals may be applied or cleared based on the preferences entered by the user. A sixth modified example, in which a user may operate the operation panel 68 to apply or clear the settings of the particular signals, will be described below. In the printer 1 according to the sixth modified example, the controller 80 executes a process as shown in FIG. 13A.

In particular, when the user operates the operation panel 68 for entering the settings of the particular signals, the controller 80 controls the operation panel 68 to display a setting screen 100 as shown in FIG. 13B (S701).

As shown in FIG. 13B, the setting screen 100 includes a message field 101, a plurality of selectable-event fields 102, a plurality of checkboxes 103, and an enter icon 104. The message field 101 is a field, in which a message prompting the user to select events to trigger the discharge-testing process and the storing process is displayed.

The plurality of selectable-event fields 102 are arranged vertically, and in each of the plurality of selectable-event fields 102, an event that may trigger the discharge-testing process and the storing process is displayed. An event “Awaking from sleep” shown in FIG. 13B corresponds to “Signal indicating that the printer shifted from the sleep mode to the record-standby mode” listed in FIG. 7A. An event “Setting for recording being entered” shown in FIG. 13B corresponds to “Signal indicating the record-setting icon having been operated” and “Signal indicating entry of settings for image recording in the external device” listed in FIG. 7A. An event “Recording sheet being placed” shown in FIG. 13B corresponds to “Signal indicating the recording sheet being placed” listed in FIG. 7A. An event “Readable material being placed” shown in FIG. 13B corresponds to “Signal indicating a readable material being placed on the reading table” listed in FIG. 7A. An event “Replacing cartridge” shown in FIG. 13B corresponds to “Signal indicating an ink cartridge being replaced with another” listed in FIG. 7A. An event “External memory device being connected” shown in FIG. 13B corresponds to “Signal indicating an external memory device being connected” listed in FIG. 7A. An event “Communication established” shown in FIG. 13B corresponds to “Signal indicating communication with an external device being established” listed in FIG. 7A.

The plurality of checkboxes 103 are provided to the plurality of selectable-event fields 102 in one-to-one correspondence and are each located rightward from the corresponding one of the plurality of selectable-event fields 102. The user may place or remove checkmarks in the checkboxes 103 by operating the operation panel 68 to apply or clear the settings of the signals corresponding to the selectable-event fields 102 as the particular signals. The enter icon 104 is a part of the operation panel 68 to be operated by the user for entering the preferences of the events that may trigger the discharge-testing process and the storing process.

As shown in FIG. 13A, the controller 80 controls the operation panel 68 to display the setting screen 100 in S701 and waits until the user's input through the setting screen 100 is completed (S702: NO). The user's input through the setting screen 100 may be completed when the user operates the enter icon 104. When the user's input through the setting screen 100 is completed (S702: YES), the controller 80 controls the operation panel 68 to close the setting screen 100 (S703). Thereafter, the controller 80 sets the selected signals as the particular signals and/or clears the settings of the particular signals corresponding to the selected signals based on the user's preferences entered through the setting screen 100 (S704). In particular, the controller 80 sets, as the particular signals, the signals in the selectable-event fields 102 with the checkboxes 103, in which the checkmarks are placed and clears the settings of the particular signals corresponding to the signals in the selectable-event fields 102 with the checkboxes 103, in which no checkmark is placed.

In the sixth modified example, entry of the user's preferences for setting the signals as the particular signals by placing the checkmarks in the checkboxes 103 with use of the operation panel 68 corresponds to a condition for applying the settings as the particular signals, and entry of the user's preferences for clearing the settings as the particular signals by removing the checkmarks from the checkboxes 103 with use of the operation panel 68 corresponds to a condition for clearing the settings of the particular signals.

According to the sixth modified example, the user's preferred signals among the signals, as listed in FIG. 7A, that the controller 80 may receive before the record command is received may be set as the particular signals.

According to the sixth modified example, further, among the signals set as the particular signals, the setting as the particular signal may be cleared from the signal selected by the user.

In the fifth modified example described earlier, both applying and clearing the setting of the particular signal to and from the signal are based on the length of the time period from the time when the signal is received to the time when the record command is received, and in the sixth modified example, both applying and clearing the setting of the particular signal to and from the signal are based on the preferences entered by the user. However, the setting of the particular signal may be applied to or cleared from the signal not necessarily both based on the same condition. For example, one of applying and clearing of the setting as the particular signal may be based on the length of the time period from the time when the signal is received to the time when the record command is received, and the other of applying and clearing of the setting of the particular signal may be based on the preference entered by the user.

For another example, the settings of the particular signals may not necessarily be applicable or clearable. For example, all of the signals listed in FIG. 7A may be set initially as the particular signals, and each setting as the particular signal may be clearable based on the length of the time period from the time when the signal is received to the time when the record command is received or based on the user's preference. For another example, none of the signals listed in FIG. 7A may be set initially as the particular signal, and each setting as the particular signal may be applicable based on the length of the time period from the time when the signal is received to the time when the record command is received or based on the user's preference.

For another example, among the signals that may be received before a record command is received, a signal that satisfies a condition other than the conditions described in the fifth or sixth modified example may be set as the particular signal. Moreover, among the signals that are set as the particular signals, the setting as the particular signal may be cleared from the signal that satisfies a condition other than the conditions described in the fifth or sixth modified example.

For another example, the signal indicating communication with an external device 98 being established may not necessarily be limited to the signal output from the communication interface 66 when the external device 98 is connected to the communication interface 66 directly or indirectly through the network. In this regard, a seventh modified example will be described below.

In the seventh modified example, information concerning the particular signals as listed in FIG. 14 is stored in the flash memory 84. In the list shown in FIG. 14, “Signal indicating communication with an external device being established” listed in FIG. 7A is replaced with “Signal to be output when an application program that may transmit a record command from an external device is activated.”

“Signal to be output when an application program that may transmit a record command from the external device is activated” listed in FIG. 14 may be, for example, a signal that may be transmitted from the external device 98 to the printer 1 when an application program, which is installed in the external device 98 and may transmit a record command to the printer 1, is activated, and the application program conducts a process to acquire information concerning the printer 1.

The application program, which is installed in the external device 98 and may transmit a record command to the printer 1, may transmit the record command from the external device 98 to the printer 1 when communication between the printer 1 and the external device 98 is established and the printer 1 and the external device 98 are enabled to communicate with each other. Meanwhile, even when the printer 1 and the external device 98 are enabled to communicate with each other, if the application program that may transmit a record command to the printer 1 is not activated, it may be unlikely that the external device 98 transmits a record command to the printer 1. Therefore, in the seventh modified example, a signal to be transmitted from the external device 98 to the printer 1 when the application program in the external device 97 that may transmit the record command to the printer 1 is activated is equated to the signal indicating that the communication with the external device is established.

For another example, the signal indicating that the communication with the external device is established may not necessarily be limited to the signal that may be transmitted from the external device 98 to the printer 1 when the application program that may transmit a record command to the printer 1 is activated, as illustrated in the seventh modified example. For example, a signal, other than the record command, which may be produced by the application program that may transmit the record command to the printer 1, in response to an event other than activation of the application program, may be equated to the signal indicating that the communication with the external device is established.

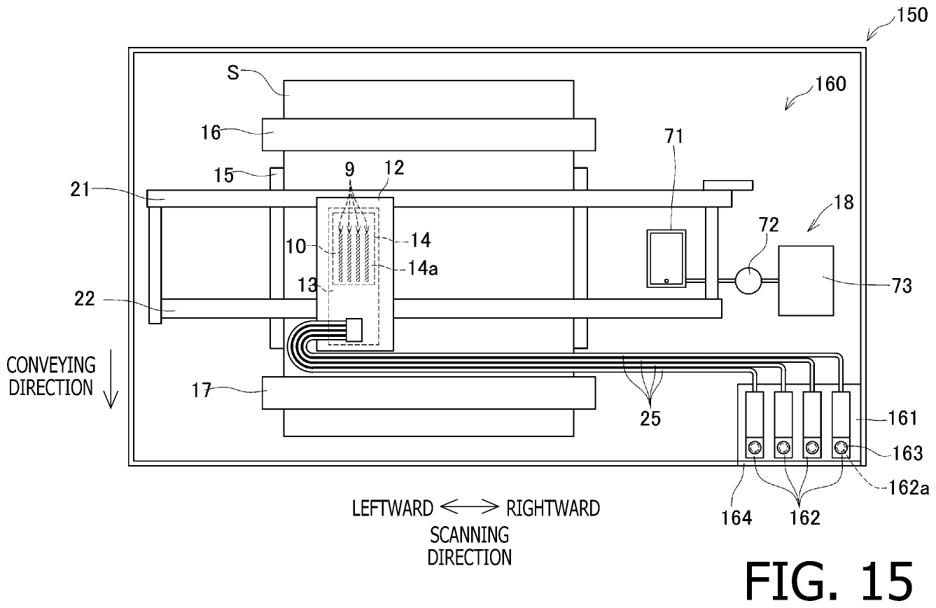

In the embodiment and the modified examples described above, the printer 1 has the cartridge-attachable compartment 23, and when the ink cartridges 24 containing the inks are attached to the cartridge-attachable compartment 23, the inks may be supplied to the inkjet head 14. However, the inks may not necessarily be supplied to the inkjet head 14 in this arrangement. In this regard, an eighth modified example will be described below with reference to FIG. 15.

In the eighth modified example, as shown in FIG. 15, a printer 150 includes a recorder 160, which replaces the recorder 3 in the printer 1 described above. The recorder 160 includes a tank compartment 161 and four ink tanks 162, which replace the cartridge-attachable compartments 23 and the four ink cartridges 24, respectively.

In the eighth modified example, the four ink tanks 162 are aligned in the scanning direction and accommodated in the tank compartment 161. In the four ink tanks 162, inks in the colors of black, yellow, cyan, and magenta are contained in this given order from right to left in the scanning direction. Each ink tank 162 has a supply port 162a, through which the ink in each color may be supplied to the ink tank 162 externally. The supply port 162a is covered with a removable tank cap 163.

On a downstream end of the tank compartment 161 in the conveying direction, a tank-compartment cover 164, which is openable and closable with respect to the tank compartment 161, is provided. When the tank-compartment cover 164 is closed, the tank compartment 161 is covered with the tank-compartment cover 164. When the tank-compartment cover 164 is opened, the tank compartment 161 is exposed. Therefore, when the tank cap 163 is removed from the supply port 162a, the ink may be supplied from the outside to the ink tank 162 through the supply port 162a.

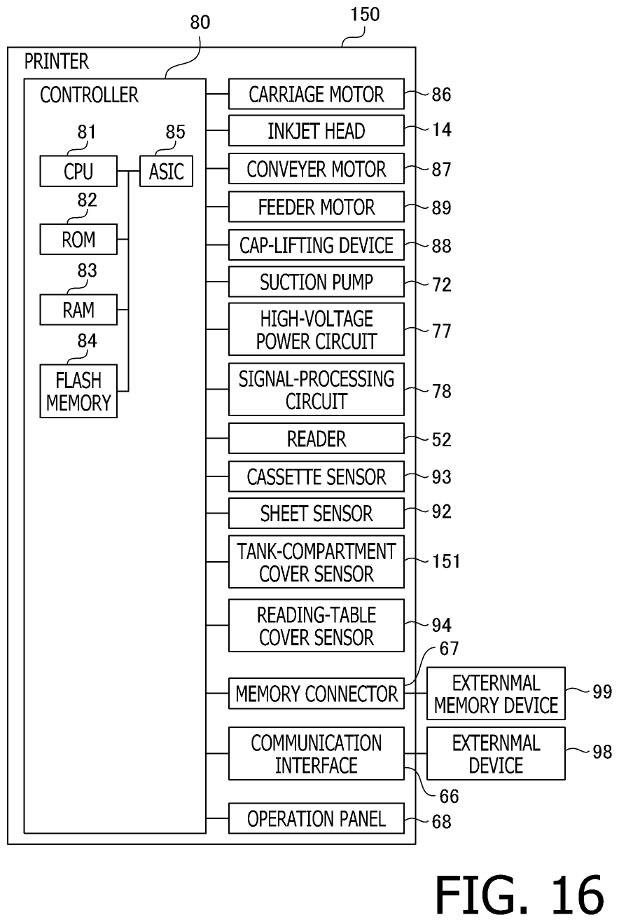

As shown in FIG. 16, the printer 150 includes a tank-compartment cover sensor 151 in place of the cartridge sensors 91 in the printer 1 described above. The tank-compartment cover sensor 151 is provided to the tank-compartment cover 164 and may output a signal indicating whether the tank-compartment cover 164 is open or closed.

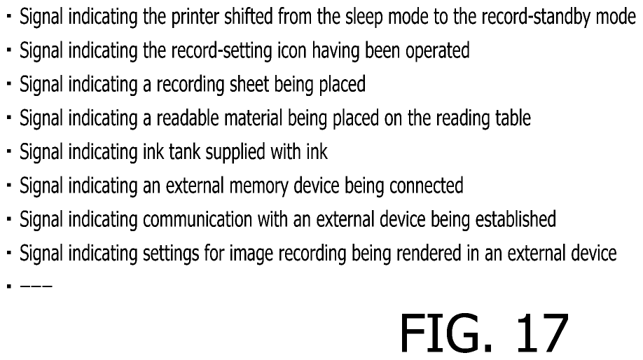

Moreover, in the eighth modified example, information concerning the particular signals as listed in FIG. 17 are stored in the flash memory 84. In the list shown in FIG. 17, “Signal indicating ink tank supplied with ink” replaces “Signal indicating an ink cartridge being replaced with another” listed in FIG. 7A.

The signal indicating the ink tank supplied with the ink may be output from the tank-compartment cover sensor 151 when the tank-compartment cover 164 is opened and thereafter closed.

In the eighth modified example, when the ink tank 162 is supplied with the ink, it may be likely that the controller 80 receives a record command thereafter. Therefore, the signal indicating the ink tank 162 is supplied with the ink is set as the particular signal. When the ink tank 162 is to be supplied with the ink, the tank-compartment cover 164 is opened, the tank cap 63 is removed from the ink tank 162, and the ink is supplied to the ink tank 162 from the outside through the supply port 162a. Thereafter, the tank cap 63 is attached to the ink tank 162, and the tank-compartment cover 164 is closed. Therefore, in the eighth modified example, the signal output from the tank-compartment cover sensor 151 when the tank-compartment cover 164 is opened and thereafter closed is equated to the signal indicating the ink tank 162 is supplied with the ink.

Meanwhile, the signal indicating that the ink cartridge 24 is replaced with another, as described in the embodiment above, may not necessarily be limited to the signal output from the cartridge sensor 91 when the ink cartridge 24 is attached to the cartridge-attachable compartment 23. For example, a sensor that may output signals corresponding to opening and closing acts of the cartridge cover 26 may be provided, and a signal output from the sensor when the cartridge cover 26 is opened and thereafter closed may be equated to the signal indicating that the ink cartridge 24 is replaced with another. For another example, a signal that may be output from the operation panel 68 when the user inputs an operation corresponding to an act of replacing the ink cartridge 24 with another ink cartridge 24 to the operation panel 68 may be equated to the signal indicating that the ink cartridge 24 is replaced with another.

For another example, the signal indicating the ink tank 162 being supplied with the ink may not necessarily be limited to the signal output from the tank-compartment cover sensor 151 when the tank-compartment cover 164 is opened and thereafter closed, as described in the eighth modified example. For example, a sensor that may output a signal corresponding to an amount of the ink contained in the ink tank 162, indicating whether the amount of the ink is greater than or equal to a predetermined amount or not, may be provided, and a signal, which may be output from the sensor when the amount of the ink being smaller than the predetermined amount changes to an amount greater than or equal to the predetermined amount, may be equated as the signal indicating that the ink tank 162 supplied with the ink. For another example, a signal that may be output from the operation panel 68 when the user inputs an operation corresponding to an act of supplying the ink to the ink tank 162 through the operation panel 68 may be equated to the signal indicating the ink tank 162 supplied with the ink.

For another example, among the plurality of icons 61 in the operation screen 60 displayed in the operation panel 68 in the embodiment described above, the icon to be operated to cause the operation panel 68 to output the signal that may be determined as the particular signal may not necessarily be limited to the record-setting icon 61a. For example, a signal that may be output from the operation panel 68 when another one of the plurality of icons 61 different from the record-setting icon 61a is operated may be set as the particular signal. For another example, a signal that may be output from the operation panel 68 when the operation panel 68 is operated, regardless of whether the operation is rendered to the icons 61 or not, may be set as the particular signal.

For another example, in the embodiment described above, the signal that the controller 80 may receive when the printer 1 shifts from the sleep mode to the record-standby mode is determined as the particular signal. However, the operation mode, from which the printer 1 may shift to the record-standby mode to cause the signal to be received by the controller 80 may not necessarily be limited to the sleep mode. For example, a signal that may be received by the controller 80 when the printer 1 shifts to the record-standby mode from another mode, which requires a longer time before image recording on the recording sheet S starts than the record-standby mode, may be set as the particular signal.

Furthermore, the signals to be set as the particular signals may not necessarily be limited to those listed in the embodiment and the modified examples described above. For example, merely some of the signals among the signals listed above may be set as the particular signals. For another example, the signals to be set as the particular signals may include another signal that may be received by the controller 80 in response to an operation to the printer 1, 150 rendered by the user before entering the record command. For another example, the signals to be set as the particular signals may include a signal that may be received by the controller 80 in response to an operation to the printer 1, 150 entered by the user in other timing than the timing before the user enters the record command. For another example, the signals to be set as the particular signals may include a signal irrelevant to the operations to the printer 1, 150 entered by the user.

For another example, the operation panel 68 may not necessarily be limited to the touch panel but may include, for example, a combination of a display device such as a liquid crystal display and an operation device such as buttons arranged outside of the display device.

For another example, the printer 1 may not necessarily perform the suction-purging act for expelling the ink from the nozzles 10 of the inkjet head 14. For example, a pressurizing pump that may pressurize the ink in the inkjet head 14 may be provided in flow paths between the ink cartridges 24 and the inkjet head 14 to perform a pressurized-purging act. For the pressurized-purging act, the pressurizing pump may be activated while the nozzles 10 are covered with the cap 71, and thereby, the ink may be expelled from the inkjet head 14. In this arrangement, the cap 71 and the pressurizing pump are another example of the expelling device.

For another example, the printer 1 may perform both the suction-purging act to expelling the ink from the nozzles 10 by driving the suction pump 72 and the pressurized-purging act to expel the ink from the nozzles 10 by driving the pressurizing pump. In this arrangement, the cap 71, the suction pump 72, the waste liquid tank 73, and the pressurizing pump are another example of the expelling device.

For another example, the condition signals indicating the conditions of the nozzles 10 may not necessarily be output from the signal-processing circuit 78 according to the change of the voltage in the electrode 76 located inside the cap 71a when the inkjet head 14 is driven to discharge the ink.

For example, an electrode extending vertically and facing toward the nozzle surface 14a when the carriage 12 is located at the maintenance position may be provided to replace the electrode 76. The signal-processing circuit 78 may output the condition signals according to the change of the voltage in the electrode when the inkjet head 14 is driven to discharge the ink on the carriage 12 being located at the maintenance position.

For another example, an optical sensor that may directly detect the ink discharged from the nozzles 10 of the inkjet head 14 on the carriage 12 being located at a predetermined position, such as the maintenance position, may be provided, and the optical sensor may output the condition signals according to the detected results.

For another example, as disclosed in Japanese Patent No. 4929699, a voltage detecting circuit to detect changes in the voltage when the ink is discharged from the nozzles may be connected to a plate, in which the nozzles are formed, in the inkjet head, and the voltage-detecting circuit may output condition signals according to the changes in the voltage when the ink is discharged from the nozzles of the inkjet head on the carriage being located at a testing position.

For another example, as disclosed in Japanese Patent No. 6231759, a temperature-detecting element may be provided to a substrate of the inkjet head having a heater. With the temperature-detecting element in the inkjet head, a first voltage for discharging the ink may be applied to drive the heater, and thereafter, a second voltage for not discharging the ink may be applied to control the heater. Condition signals may be output from the inkjet head based on the change of the temperature detected by the temperature-detecting element within a time period between the time when the second voltage is applied to the heater and a time when a predetermined length of time elapses.

For another example, the printer 1 may be operated to record a test pattern on the recording sheet S for testing whether the nozzles 10 are functioning correctly or malfunctioning, and the malfunctioning nozzles may be determined based on the recorded outcome of the test pattern. In this arrangement, for example, the condition signals according to the recorded outcome of the test pattern may be output from the operation panel 68 of the printer 1 or from the external device 98 to the controller 80 by an operation to the operation panel 68 or to the external device 98 rendered by the user.

For another example, not all of the nozzles 10 in the inkjet head 14 may necessarily be driven for testing to determine malfunctioning of the nozzles 10. For example, merely a part of the nozzles 10 in the inkjet head 14, such as one of every two nozzles 10 in each nozzle row 9, may be driven for testing to determine whether the nozzles 10 are malfunctioning, and the other untested nozzles 10 may be considered to be malfunctioning nozzles 10 based on the condition of the part of the nozzles 10.

For another example, the condition signals may not necessarily indicate sufficiency or insufficiency of the amount of the discharged ink. For example, the condition signals may indicate whether a state of the discharged ink is poor or fair. For example, the condition signals may be signals indicating whether the nozzles 10 are in a difficult condition to record an image correctly and may indicate, for example, whether viscosity of the ink in the nozzles 10 is high or not, whether the discharged ink skews or not, whether the amount of the discharged ink is smaller than or equal to a predetermined amount or not.

For another example, the inkjet head 14 may not necessarily be limited to the serial head, which may move in the scanning direction along with the carriage while discharging the ink from the nozzles 10, but may be a line head, which extends entirely over a length of the recording sheet S in the scanning direction.

For another example, the present disclosure may not necessarily be applied to the printer that may record an image on the recording sheet S by discharging the ink from the nozzles, but may be applied to a recording apparatus that may record an image on a recordable medium other than the recording sheet, such as T-shirt, sheet for outdoor advertisement, case for mobile terminal such as smartphone, cardboard, resin piece, etc.

What is claimed is:

1. An image recording apparatus, comprising:
a head having nozzles, the head being configured to discharge liquid from the nozzles for recording an image on a recording medium;
an expelling device configured to expel the liquid from the nozzles;
a discharge-testing device configured to output condition signals according to discharging conditions of the nozzles;
a storage configured to store information concerning the condition signals; and
a controller configured to:
in response to receipt of a record command for recording the image, control the expelling device to expel the liquid from the nozzles based on the information concerning the condition signals stored in the storage, and thereafter, control the head to discharge the liquid for recording the image on the recording medium; and
in response to receipt of a particular signal, the particular signal indicating a potential for receiving the record command, execute a discharging-test process in which the controller controls the discharge-testing device to output the condition signals according to the discharging conditions of the nozzles, and a storing process in which the information concerning the condition signals is stored in the storage.

2. The image recording apparatus according to claim 1, wherein the controller is configured to:
based on that the particular signal received is a first particular signal received within a predetermined time period, execute the discharging-test process and the storing process; and
based on that the particular signal received is a second or subsequent particular signal received within the predetermined time period, neither control the discharge-testing device to output the condition signals nor store the information concerning the condition signals in the storage.

3. The image recording apparatus according to claim 1, wherein the controller is configured to:
based on that the record command is a first record command received within a predetermined time period, control the expelling device to expel the liquid from the nozzles, and after the expelling device finishes expelling the liquid from the nozzles, control the head to discharge the liquid for recording the image; and
based on that the record command is a second or subsequent record command received within the predetermined period, without causing the expelling device to expel the liquid from the nozzles, control the head to discharge the liquid for recording the image.

4. The image recording apparatus according to claim 1, wherein the controller is configured to, in response to receipt of the record command during the discharging-test process and the storing process:
control the expelling device to expel the liquid from the nozzles after finishing the discharging-test process and the storing process; and
control the head to discharge the liquid for recording the image after the expelling device finishes expelling the liquid from the nozzles.

5. The image recording apparatus according to claim 1, wherein the controller is configured to, in response to receipt of the record command during the discharging-test process and the storing process,
control the head to discharge the liquid for recording the image after finishing the discharging-test process and the storing process, without causing the expelling device to expel the liquid from the nozzles.

6. The image recording apparatus according to claim 5, wherein the controller is configured to control the expelling device to expel the liquid from the nozzles after the head finishes discharging the liquid for recording the image.

7. The image recording apparatus according to claim 1, wherein the controller is configured to, in response to receipt of the record command during the discharging-test process and the storing process:
discontinue the discharging-test process and the storing process;
control the expelling device to expel the liquid from the nozzles based on information concerning condition signals stored in the storage in an earlier storing process before the controller discontinues the storing process; and
after the expelling device finishes expelling the liquid, control the head to discharge the liquid for recording the image.

8. The image recording apparatus according to claim 1, wherein the controller is configured to, in response to receipt of the record command during the discharging-test process and the storing process:
suspend the discharge-testing process and the storing process; and
without causing the expelling device to expel the liquid from the nozzles, control the head to discharge the liquid for recording the image.

9. The image recording apparatus according to claim 8, wherein the controller is configured to:
after recording of the image, resume the discharge-testing process and the storing process; and
after finishing the discharging-test process and the storing process, control the expelling device to expel the liquid from the nozzles.

10. The image recording apparatus according to claim 1, wherein the controller is configured to set, as the particular signal, a signal received prior to receipt of the record command satisfying a condition.

11. The image recording apparatus according to claim 10, wherein the condition is entry of a preference by a user for setting the signal as the particular signal.

12. The image recording apparatus according to claim 10, wherein
the controller is configured to store, in the storage, a length of time from a time when the signal received prior to receipt of the record command is received to a time when the record command is received, and
the condition is related to the length of the time stored in the storage.

13. The image recording apparatus according to claim 1, wherein the controller is configured to clear a setting as the particular signal applied to a signal in response to the signal satisfying a condition.

14. The image recording apparatus according to claim 13, wherein the condition is entry of a preference by a user for clearing the setting as the particular signal from the signal.

15. The image recording apparatus according to claim 14, wherein
the controller is configured to store, in the storage, a length of time from a time when the signal set as the particular signal is received to a time when the record command is received, and
the condition is related to the length of the time stored in the storage.

16. The image recording apparatus according to claim 1, wherein the particular signal is to be received by the controller in response to an operation to the image recording apparatus rendered by a user before entering the record command.

17. The image recording apparatus according to claim 16, configured to stay in one of:
a record-standby mode in which the image recording apparatus is ready to start recording the image on the recording medium; and
another mode in which the image recording apparatus takes a longer time to start recording the image on the recording medium than the time taken by the image recording apparatus in the record-standby mode,
wherein the particular signal indicates that the image recording apparatus shifted from the another mode to the record-standby mode.

18. The image recording apparatus according to claim 16, further comprising a sensor configured to detect the operation to the image recording apparatus rendered by the user,
wherein the particular signal is to be transmitted from the sensor.

19. The image recording apparatus according to claim 16, further comprising an operation panel to be operated by the user,
wherein the particular signal indicates the operation panel having been operated by the user.

20. The image recording apparatus according to claim 19, wherein the operation panel has an icon-display area in which a particular icon is displayed,
wherein the particular signal indicates the particular icon having been operated by the user.

21. The image recording apparatus according to claim 20, wherein the particular icon is related to a setting for recording the image on the recording medium.

22. The image recording apparatus according to claim 1, further comprising a medium-placement section on which the recording medium is placed by a user,
wherein the particular signal indicates that the recording medium is placed on the medium-placement section.

23. The image recording apparatus according to claim 1, further comprising:
a reading table on which a readable object is to be placed; and
a reader configured to read the readable object placed on the reading table,
wherein the particular signal indicates that the readable object is placed on the reading table.

24. The image reading apparatus according to claim 1 further comprising a cover being openable and closable,
wherein the particular signal indicates the cover being open or closed.

25. The image recording apparatus according to claim 24, further comprising:
a reading table on which a readable object is to be placed; and
a reader configured to read the readable object placed on the reading table,
wherein the cover is movable between a closed position, at which the cover covers the reading table, and an open position, at which the reading table is exposed.

26. The image recording apparatus according to claim 24, further comprising:
a liquid tank configured to store the liquid to be supplied to the head; and
a tank compartment configured to accommodate the liquid tank,
wherein the cover is movable between a closed position, at which the cover covers the tank compartment, and an open position, at which the tank compartment is exposed.

27. The image recording apparatus according to claim 1, further comprising a liquid tank, the liquid tank being removable from the image recording apparatus and being configured to store the liquid to be supplied to the head,
wherein the particular signal indicates that the liquid tank is replaced with another liquid tank.

28. The image recording apparatus according to claim 1, further comprising a liquid tank configured to store the liquid to be supplied to the head, the liquid tank having a supply port through which the liquid is to be supplied externally to the liquid tank,
wherein the particular signal indicates that the liquid is supplied externally to the liquid tank through the supply port.

29. The image recording apparatus according to claim 1, further comprising a connector connectable with an external memory device,
wherein the particular signal indicates that the external memory device is connected to the connector.

30. The image recording apparatus according to claim 1, configured to communicate with an external device,
wherein the particular signal indicates that communication with the external device is established.

31. The image recording apparatus according to claim 30, wherein
the external device has a pre-installed application program to enable the external device to transmit, to the image recording apparatus, the record command and another signal, and
the particular signal is the another signal to be transmitted from the external device to the image recording apparatus by the application program.

32. The image recording apparatus according to claim 31, wherein the another signal is to be transmitted from the external device to the image recording apparatus when the application program is activated.

33. The image recording apparatus according to claim 30, wherein the particular signal indicates that the image recording apparatus and the external device are enabled to communicate with each other by being connected to a same network.

34. The image recording apparatus according to claim 1, configured to communicate with an external device, wherein
the external device comprises an operation interface configured to allow a user to enter a setting for recording the image on the recording medium, and
the particular signal is a signal to be transmitted from the external device to the image recording apparatus when the user enters the setting for recording the image on the recording medium through the operation interface during communication between the image recording apparatus and the external device.

35. An image recording apparatus, comprising:
a head having nozzles, the head being configured to discharge liquid from the nozzles for recording an image on a recording medium;
a receiver configured to receive the liquid discharged from the head;
a discharge-testing device configured to output condition signals according to discharging conditions of the nozzles;
a storage configured to store information concerning the condition signals; and
a controller configured to:
in response to receipt of a record command for recording the image, control the head to expel the liquid from the nozzles at the receiver based on the information concerning the condition signals stored in the storage, and thereafter, control the head to discharge the liquid for recording the image at the recording medium; and
in response to receipt of a particular signal, the particular signal indicating a potential for receiving the record command, execute a discharging-test process in which the controller controls the discharge-testing device to output the condition signals according to the discharging conditions of the nozzles, and a storing process in which the information concerning the condition signals is stored in the storage.
